(19) United States
(12) Patent Application Publication
(10) Pub. No.: US 2026/0350595 A1
(43) Pub. Date: Nov. 5, 2026

(54) System, Method, and Computer Program Product for Key-Value Commitments From Accumulators and Vector Commitments

(71) Applicant: Visa International Service Association, San Francisco, CA (US)

(72) Inventors: Ioanna Karantaidou, Washington, DC (US); Srinivasan Raghuraman, Cambridge, MA (US)

(21) Appl. No.: 19/488,197

(22) PCT Filed: May 29, 2024
(86) PCT No.: PCT/US2024/031372

§ 371 Date: Nov. 26, 2025

Related U.S. Application Data
(60) Provisional application No. 63/469,961, filed on May 31, 2023.

(51) Int. Cl. G06Q 20/38; G06Q 20/40

(52) U.S. Cl. CPC G06Q 20/38215; G06Q 20/3829; G06Q 20/389; G06Q 20/401

(57) ABSTRACT

System, method, and computer program products are provided for key-value commitments from accumulators and vector commitments. The system includes at least one processor, configured to generate an accumulator commitment for a plurality of key-value pairs of a block in a blockchain network, the accumulator commitment cryptographically adding each key-value commitment of the block; obtain a new transaction for the block; determine a membership proof or non-membership proof to verify at least one accumulated value from one or more previous transactions; and authenticate the new transaction based on at least one proof to verify membership or non-membership based on the at least one accumulated value.

### CROSS-REFERENCE TO RELATED APPLICATIONS

This application is the United States national phase of International Application No. PCT/US24/31372, filed on May 29, 2024, and claims priority to U.S. Provisional Patent Application No. 63/469,961, filed on May 31, 2023, the disclosures of which are hereby incorporated by reference in their entireties.

### BACKGROUND

### 1. Technical Field

This disclosure relates generally to cryptographic primitives, properties, and, in some non-limiting embodiments or aspects, to systems, methods, and computer program products for key-value commitments from accumulators and vector commitments.

### 2. Technical Considerations

A state of the blockchain network is represented by a key-value map (M), including one or more keys that represent the public addresses of the parties (e.g., users, entities, etc.) involved, and one or more values that represent the attributes associated with the keys (e.g., transactions, balance amount, transaction details, smart contracts, a nonce used only once, etc.).

The key-value map provides a snapshot of the blockchain network (e.g., the entire blockchain network, complete blockchain network at a particular point in time, etc.). The snapshot represents the current state of the blockchain network, used by nodes of the blockchain network to validate transactions, enforce rules, and maintain consensus across a specified blockchain network. The snapshot includes data and information necessary to determine the current state and condition of each element of the blockchain network (e.g., details required to represent the state of the blockchain network accurately at a specific point in time).

When transacting to transfer an amount to another user, the key-value map is used to check if the user based on their public key has a balance of at least the amount transferred. On confirmation of the transaction, the balance of the parties may be updated in a key-value map.

However, blockchain (e.g., cryptocurrency, etc.) networks have experienced significant growth since the introduction of Bitcoin. With significant increases in the number of transactions, blockchains, in particular cryptocurrencies, are expected to experience substantially greater throughputs with many more additional accounts.

However, new scalability challenges associated with decentralization, a key principle in cryptocurrency technology, necessitate distributed systems to control decision-making among cryptocurrency network participants. As the number of users increases and new accounts are created, the size of the key-value map continuously grows, and the cost of resources (including operation thereof) for cryptocurrency and other blockchain networks increase.

To adjust the resource demands incurred as a result of the large growth, many users are turning to third parties for information about the state of a blockchain network. For example, many users now rely on third-party systems, such as centralized exchanges or service providers, for obtaining access to information about the state of the system. These third parties are convenient to use and provide access to a state of a cryptocurrency network without requiring users to bear the burden of maintaining a complete node. However, this reliance on third party systems undermines the vitality of the decentralized nature of such a cryptocurrency network by leading a significant portion of users to rely on third-party resources for information about the system's state. Also, as the number of users and accounts grow for a particular cryptocurrency network, the size of the key-value map also increases resulting in higher resource costs for running a node as existing systems have not provided solutions for optimizing mechanisms to efficiently and accurately maintain the decentralization, security, and performance of the cryptocurrency network.

### SUMMARY

Accordingly, provided are improved systems, methods, and computer program products for key-value commitments from accumulators and vector commitments.

According to non-limiting embodiments or aspects, provided is a system, comprising: at least one processor, configured to: generate an accumulator commitment for a plurality of key-value pairs of a block in a blockchain network, the accumulator commitment cryptographically adding each key-value commitment of the block; obtain a new transaction for the block; determine a membership proof or non-membership proof to verify at least one accumulated value from one or more previous transactions; and authenticate the new transaction based on at least one proof to verify membership or non-membership based on the at least one accumulated value.

In non-limiting embodiments or aspects, the at least one processor is further programmed or configured to: determine a multi-hop proof for a plurality of transactions; generate a vector commitment from the accumulator commitment by converting each key-value commitment of the plurality of key-value pairs of the accumulator commitment to a corresponding key-value commitment of the vector commitment; authenticate at least one second transaction by using at least one property of the vector commitment to execute the multi-hop proof; and update the accumulator commitment by adding a key-value pair to the accumulator commitment for the second transaction in response to verifying the second transaction based on the vector commitment.

In non-limiting embodiments or aspects, wherein generating the vector commitment from the accumulator commitment extends at least one property of the accumulator commitment to include one or more properties of the vector commitment to operate on the plurality of key-value pairs, the vector commitment increases in length to commit each key-value commitment stored by the accumulator commitment, and the increases in the length of the vector commitment comprise a plurality of keys that commit a domain of the accumulator commitment.

In non-limiting embodiments or aspects, the at least one processor is further programmed or configured to: determine a current state of the blockchain network based on combining the accumulator commitment of a current block of the blockchain network with each previous accumulator commitment representing each previous block of the blockchain network, wherein a state of each previous block is determined by a commitment value of a key-value map stored for each previous block of the blockchain network, the accumulator commitment includes a key-value map associated with the current state of the current block, the current state of the blockchain network is determined by accumulating each accumulator commitment stored in each previous block of the blockchain network, wherein each new block in the blockchain network stores a reference back to a accumulator commitment of a previous block of the blockchain network, and wherein one or more key-value pairs of the accumulator commitment of the previous block comprises information that verifies at least one transaction of the current block.

In non-limiting embodiments or aspects, the at least one processor is further programmed or configured to: transform each key-value pair of the plurality of key-value pairs of the accumulator commitment by: encode a plurality of keys of the plurality of key-value pairs into a probabilistic data structure by encoding the plurality of keys to include a test indicator that provides a signal in response to determining a specified key is in a set; and compress a plurality of values of the plurality of key-value pairs into a compact format that provides access to information associated with the plurality of values when compared to one or more test values.

In non-limiting embodiments or aspects, the at least one processor is further programmed or configured to: generate a compact representation of the plurality of keys by hashing each key of the plurality of keys and resetting bits for each hashed key based on one or more resulting hash values, the compact representation of the plurality of keys is configured to store the plurality of keys and information for querying the one or more key-value pairs.

In non-limiting embodiments or aspects, the accumulator commitment is associated with a key-value map, wherein access to a plurality of values of the accumulator commitment is provided in response to a proof of knowledge determination of the key-value map for a key in the accumulator commitment, and wherein one or more blocks participate in transaction verification based only on commitment to a state without storing a current state of the blockchain network.

In non-limiting embodiments or aspects, the state of each previous block in the blockchain network is cryptographically included in each subsequent block as a commitment to a previous state of the blockchain network.

In non-limiting embodiments or aspects, wherein each encoded key of a plurality of encoded keys of the accumulator commitment are each represented by a corresponding hexadecimal string based on the one or more key-value pairs and are compacted to between 2-bytes and 6-bytes.

According to non-limiting embodiments or aspects, provided is a computer-implemented method, comprising: Generating an accumulator commitment for a plurality of key-value pairs of a block in a blockchain network, the accumulator commitment cryptographically adding each key-value commitment of the block; obtaining a new transaction for the block; determining a membership proof or non-membership proof to verify at least one accumulated value from one or more previous transactions; and authenticating the new transaction based on at least one proof to verify membership or non-membership based on the at least one accumulated value.

In non-limiting embodiments or aspects, comprising determining a multi-hop proof algorithm for a second transaction; generating a vector commitment from the accumulator commitment by converting each key-value commitment of the plurality of key-value pairs of the accumulator commitment to a corresponding key-value commitment of the vector commitment; authenticating the second transaction using at least one property of the vector commitment to execute the multi-hop proof algorithm; and updating the accumulator commitment by adding a key-value pair to the accumulator commitment for the second transaction in response to verifying the second transaction based on the vector commitment.

In non-limiting embodiments or aspects, wherein generating the vector commitment from the accumulator commitment extends at least one property of the accumulator commitment to include one or more properties of the vector commitment to operate on the plurality of key-value pairs, the vector commitment increases in length to commit each key-value commitment stored by the accumulator commitment, and the increases in the length of the vector commitment comprise a plurality of keys that commit a domain of the accumulator commitment.

In non-limiting embodiments or aspects, further comprising determining a current state of the blockchain network based on combining the accumulator commitment of a current block of the blockchain network with each previous accumulator commitment representing each previous block of the blockchain network, wherein a state of each previous block is determined by a commitment value of a key-value map stored for each previous block of the blockchain network, the accumulator commitment includes a key-value map associated with the current state of the current block, the current state of the blockchain network is determined by accumulating each accumulator commitment stored in each previous block of the blockchain network, wherein each new block in the blockchain network stores a reference back to a accumulator commitment of a previous block of the blockchain network, and wherein one or more key-value pairs of the accumulator commitment of the previous block comprises information that verifies at least one transaction of the current block.

In non-limiting embodiments or aspects, further comprising transforming each key-value pair of the plurality of key-value pairs of the accumulator commitment by: encode a plurality of keys of the plurality of key-value pairs into a probabilistic data structure by encoding the plurality of keys to include a test indicator that provides a signal in response to determining a specified key is in a set; and compress a plurality of values of the plurality of key-value pairs into a compact format that provides access to information associated with the plurality of values when compared to one or more test values.

In non-limiting embodiments or aspects, wherein encoding the plurality of keys using a probabilistic data structure comprises: generating a compact representation of the plurality of keys by hashing each key of the plurality of keys and resetting bits for each hashed key based on one or more resulting hash values, the compact representation of the plurality of keys is configured to store the plurality of keys and information for querying the one or more key-value pairs.

In non-limiting embodiments or aspects, the accumulator commitment is associated with a key-value map, wherein access to a plurality of values of the accumulator commitment is provided in response to a proof of knowledge determination of the key-value map for a key in the accumulator commitment, and wherein one or more blocks participate in transaction verification based only on commitment to a state without storing a current state of the blockchain network.

In non-limiting embodiments or aspects, the state of each previous block in the blockchain network is cryptographically included in each subsequent block as a commitment to a previous state of the blockchain network.

In non-limiting embodiments or aspects, wherein each encoded key of a plurality of encoded keys of the accumulator commitment are each represented by a corresponding hexadecimal string based on the one or more key-value pairs and are compacted to between 2-bytes and 6-bytes.

According to non-limiting embodiments or aspects, provided is a computer program product, comprising at least one non-transitory computer-readable medium including program instructions that, when executed by at least one processor, cause the at least one processor to: generate an accumulator commitment for a plurality of key-value pairs of a block in a blockchain network, the accumulator commitment cryptographically adding each key-value commitment of the block; obtain a new transaction for the block; determine a membership proof or non-membership proof to verify at least one accumulated value from one or more previous transactions; and authenticate the new transaction based on at least one proof to verify membership or non-membership based on the at least one accumulated value.

In non-limiting embodiments or aspects, the at least one non-transitory computer-readable medium includes further program instructions that, when executed by at least one processor, cause the at least one processor to: determine a multi-hop proof for a plurality of transactions; generate a vector commitment from the accumulator commitment by converting each key-value commitment of the plurality of key-value pairs of the accumulator commitment to a corresponding key-value commitment of the vector commitment; authenticate at least one second transaction by using at least one property of the vector commitment to execute the multi-hop proof; and update the accumulator commitment by adding a key-value pair to the accumulator commitment for the second transaction in response to verifying the second transaction based on the vector commitment.

According to non-limiting embodiments or aspects, provided is a system, comprising: at least one processor, configured to: generate a key-value commitment to a plurality of key-value pairs; determine a proof for a new transaction associated with a current block in a blockchain network based on an aggregation of transaction parameters from one or more previous transactions; verify the new transaction by authenticating the one or more previous transactions using a primitive of a vector commitment to solve the proof; and update the vector commitment by cryptographically adding a new key-value commitment to verify the new transaction.

In non-limiting embodiments or aspects, the at least one processor is further configured to: determine the proof for the new transaction comprises: generate a plurality of proofs, each of the plurality of proofs corresponding to an operation of the vector commitment, the plurality of proofs comprising at least one proof configured to verify a state transition in a blockchain due to an addition of the new transaction. aggregate the plurality of proofs into a batch; verify the plurality of proofs in the batch based on a single computation of the vector commitment; and generate a verification result based on verifying the plurality of proofs.

In non-limiting embodiments or aspects, the at least one processor is further configured to: generate an accumulator commitment from the vector commitment by converting each key-value pair of the plurality of key-value pairs of the vector commitment to a corresponding key-value pair of the accumulator commitment; and authenticate the new transaction by verifying membership or non-membership of the corresponding key-value pair in the accumulator commitment with at least one property of the accumulator commitment.

In non-limiting embodiments or aspects, wherein generating the accumulator commitment from the vector commitment extends the at least one property of the vector commitment to include one or more properties of the accumulator commitment for operating on a plurality of key-value commitments.

In non-limiting embodiments or aspects, the at least one processor is further configured to: authenticate without revealing one or more intermediate state transitions or an entire key-value map of the blockchain network by using at least one primitive of the accumulator commitment to execute the proof to verify at least one of a signature, a proof of membership, a state of the vector commitment, or an amount associated with at least one transaction of the one or more previous transactions, and the proof is a multi-hop proof algorithm.

In non-limiting embodiments or aspects, the at least one processor is further configured to: determine a current state of the blockchain network based on combining the vector commitment of the current block of the blockchain network with each previous vector commitment representing each previous block of the blockchain network, wherein a state of each previous block is determined by a commitment value of a key-value map stored for each previous block of the blockchain network, the vector commitment includes a key-value map associated with the current state of the current block, the current state of the blockchain network is determined by aggregating each vector commitment stored in each previous block of the blockchain network, wherein each new block in the blockchain network stores a reference back to a vector commitment of a previous block of the blockchain network, and wherein one or more key-value pairs of the vector commitment of the previous block comprises information that verifies at least one transaction of the current block.

In non-limiting embodiments or aspects, the at least one processor is further configured to: transform each key-value pair of the plurality of key-value pairs of the vector commitment; encode a plurality of keys of the plurality of key-value pairs into a probabilistic data structure by encoding the plurality of keys to include a test algorithm that provides a signal in response to determining a specified key is in a set; and compress a plurality of values of the plurality of key-value pairs into a compact format that provides access to information associated with the plurality of values when compared to one or more test values.

In non-limiting embodiments or aspects, the at least one processor is further configured to: generate a compact representation of the plurality of keys by hashing each key of the plurality of keys and resetting bits for each hashed key based on one or more resulting hash values, the compact representation of the plurality of keys is configured to store the plurality of keys and information for querying the one or more key-value pairs.

In non-limiting embodiments or aspects, the vector commitment provides a key-value map, wherein access to a plurality of values of the vector commitment is provided in response to a proof of knowledge determination of the key-value map for a key in the vector commitment, and wherein one or more blocks participate in transaction verification based only on commitment to a state without storing a current state of the blockchain network.

In non-limiting embodiments or aspects, the state of each previous block in the blockchain network is cryptographically accumulated in each subsequent header of each subsequent block as a vector commitment to a previous state of the blockchain network.

In non-limiting embodiments or aspects, wherein encoding the vector commitment comprises encoding the plurality of values directly as a linear function to form a linear combination of one or more vector elements, and wherein additions, updates, modifications, and/or deletions of values to the vector commitment are made by updating the linear function directly, and each encoded key of a plurality of encoded keys of the vector commitment are represented by a corresponding hexadecimal string based on the one or more key-value pairs and are compacted between 2-bytes and 6-bytes.

According to non-limiting embodiments or aspects, provided is a computer-implemented method, comprising: generating a key-value commitment to a plurality of key-value pairs; determining a proof for a new transaction associated with a current block in a blockchain network based on an aggregation of transaction parameters from one or more previous transactions; verifying the new transaction by authenticating the one or more previous transactions using a primitive of a vector commitment to solve the proof; and updating the vector commitment by cryptographically adding a new key-value commitment to verify the new transaction.

In non-limiting embodiments or aspects, wherein determining the proof for the new transaction comprises: determining the proof for the new transaction comprises: generating a plurality of proofs, each of the plurality of proofs corresponding to an operation of the vector commitment, the plurality of proofs comprising at least one proof configured to verify a state transition in a blockchain due to an addition of the new transaction; aggregating the plurality of proofs into a batch; verifying the plurality of proofs in the batch based on a single computation of the vector commitment; and generating a verification result based on verifying the plurality of proofs.

In non-limiting embodiments or aspects, further comprising generating an accumulator commitment from the vector commitment by converting each key-value pair of the plurality of key-value pairs of the vector commitment to a corresponding key-value pair of the accumulator commitment; and authenticating the new transaction by verifying membership or non-membership of the corresponding key-value pair in the accumulator commitment with at least one property of the accumulator commitment.

In non-limiting embodiments or aspects, wherein generating the accumulator commitment from the vector commitment extends the at least one property of the vector commitment to include one or more properties of the accumulator commitment for operating on a plurality of key-value commitments.

In non-limiting embodiments or aspects, wherein verifying the new transaction comprises: authenticating, by a validator node, the one or more previous transactions without revealing one or more intermediate state transitions or an entire key-value map of the blockchain network by using at least one primitive of the accumulator commitment to execute the proof to verify at least one of a signature, a proof of membership, a state of the vector commitment, or an amount associated with at least one transaction of the one or more previous transactions, and the proof is a multi-hop proof algorithm.

In non-limiting embodiments or aspects, further comprising determining a current state of the blockchain network based on combining the vector commitment of the current block of the blockchain network with each previous vector commitment representing each previous block of the blockchain network, wherein a state of each previous block is determined by a commitment value of a key-value map stored for each previous block of the blockchain network, the vector commitment includes a key-value map associated with the current state of the current block, the current state of the blockchain network is determined by aggregating each vector commitment stored in each previous block of the blockchain network, wherein each new block in the blockchain network stores a reference back to a vector commitment of a previous block of the blockchain network, and wherein one or more key-value pairs of the vector commitment of the previous block comprises information that verifies at least one transaction of the current block.

In non-limiting embodiments or aspects, further comprising transforming each key-value pair of the plurality of key-value pairs of the vector commitment; encoding a plurality of keys of the plurality of key-value pairs into a probabilistic data structure by encoding the plurality of keys to include a test algorithm that provides a signal in response to determining a specified key is in a set; and compressing a plurality of values of the plurality of key-value pairs into a compact format that provides access to information associated with the plurality of values when compared to one or more test values.

According to non-limiting embodiments or aspects, provided is a computer program product, comprising at least one non-transitory computer-readable medium including program instructions that, when executed by at least one processor, cause the at least one processor to: generate a key-value commitment to a plurality of key-value pairs; determine a proof for a new transaction associated with a current block in a blockchain network based on an aggregation of transaction parameters from one or more previous transactions; verify the new transaction by authenticating the one or more previous transactions using a primitive of a vector commitment to solve the proof; and update the vector commitment by cryptographically adding a new key-value commitment to verify the new transaction.

In non-limiting embodiments or aspects, the at least one non-transitory computer-readable medium includes further program instructions that, when executed by at least one processor, cause the at least one processor to: generate a plurality of proofs, each of the plurality of proofs corresponding to an operation of the vector commitment, the plurality of proofs comprising at least one proof configured to verify a state transition in a blockchain due to an addition of the new transaction. aggregate the plurality of proofs into a batch; verify the plurality of proofs in the batch based on a single computation of the vector commitment; generate a verification result based on verifying the plurality of proofs. generate an accumulator commitment from the vector commitment by converting each key-value pair of the plurality of key-value pairs of the vector commitment to a corresponding key-value pair of the accumulator commitment; and authenticate the new transaction by verifying membership or non-membership of the corresponding key-value pair in the accumulator commitment with at least one property of the accumulator commitment.

Further non-limiting embodiments or aspects are set forth in the following numbered clauses:

Clause 1: A system, comprising: at least one processor, configured to: generate an accumulator commitment for a plurality of key-value pairs of a block in a blockchain network, the accumulator commitment cryptographically adding each key-value commitment of the block; obtain a new transaction for the block; determine a membership proof or non-membership proof to verify at least one accumulated value from one or more previous transactions; and authenticate the new transaction based on at least one proof to verify membership or non-membership based on the at least one accumulated value.

Clause 2: The system of clause 1, wherein the at least one processor is further programmed or configured to: determine a multi-hop proof for a plurality of transactions; generate a vector commitment from the accumulator commitment by converting each key-value commitment of the plurality of key-value pairs of the accumulator commitment to a corresponding key-value commitment of the vector commitment; authenticate at least one second transaction by using at least one property of the vector commitment to execute the multi-hop proof; and update the accumulator commitment by adding a key-value pair to the accumulator commitment for the second transaction in response to verifying the second transaction based on the vector commitment.

Clause 3: The system of clause 1 or 2, wherein generating the vector commitment from the accumulator commitment extends at least one property of the accumulator commitment to include one or more properties of the vector commitment to operate on the plurality of key-value pairs, wherein the vector commitment increases in length to commit each key-value commitment stored by the accumulator commitment, and the increases in the length of the vector commitment comprise a plurality of keys that commit a domain of the accumulator commitment.

Clause 4: The system of any of clauses 1-3, wherein the at least one processor is further programmed or configured to: determine a current state of the blockchain network based on combining the accumulator commitment of a current block of the blockchain network with each previous accumulator commitment representing each previous block of the blockchain network, wherein a state of each previous block is determined by a commitment value of a key-value map stored for each previous block of the blockchain network, wherein the accumulator commitment includes a key-value map associated with the current state of the current block, wherein the current state of the blockchain network is determined by accumulating each accumulator commitment stored in each previous block of the blockchain network, wherein each new block in the blockchain network stores a reference back to a accumulator commitment of a previous block of the blockchain network, and wherein one or more key-value pairs of the accumulator commitment of the previous block comprises information that verifies at least one transaction of the current block.

Clause 5: The system of any of clauses 1-4, wherein the at least one processor is further programmed or configured to: transform each key-value pair of the plurality of key-value pairs of the accumulator commitment by: encode a plurality of keys of the plurality of key-value pairs into a probabilistic data structure by encoding the plurality of keys to include a test indicator that provides a signal in response to determining a specified key is in a set; and compress a plurality of values of the plurality of key-value pairs into a compact format that provides access to information associated with the plurality of values when compared to one or more test values.

Clause 6: The system of any of clauses 1-5, wherein the at least one processor is further programmed or configured to: generate a compact representation of the plurality of keys by hashing each key of the plurality of keys and resetting bits for each hashed key based on one or more resulting hash values, wherein the compact representation of the plurality of keys is configured to store the plurality of keys and information for querying the one or more key-value pairs.

Clause 7: The system of any of clauses 1-6, wherein the accumulator commitment is associated with a key-value map, wherein access to a plurality of values of the accumulator commitment is provided in response to a proof of knowledge determination of the key-value map for a key in the accumulator commitment, and wherein one or more blocks participate in transaction verification based only on commitment to a state without storing a current state of the blockchain network.

Clause 8: The system of any of clauses 1-7, wherein the state of each previous block in the blockchain network is cryptographically included in each subsequent block as a commitment to a previous state of the blockchain network.

Clause 9: The system of any of clauses 1-8, wherein each encoded key of a plurality of encoded keys of the accumulator commitment are each represented by a corresponding hexadecimal string based on the one or more key-value pairs and are compacted to between 2-bytes and 6-bytes.

Clause 10: A computer-implemented method, comprising: Generating an accumulator commitment for a plurality of key-value pairs of a block in a blockchain network, the accumulator commitment cryptographically adding each key-value commitment of the block; obtaining a new transaction for the block; determining a membership proof or non-membership proof to verify at least one accumulated value from one or more previous transactions; and authenticating the new transaction based on at least one proof to verify membership or non-membership based on the at least one accumulated value.

Clause 11: The computer-implemented method of clause 10, comprising: determining a multi-hop proof algorithm for a second transaction; generating a vector commitment from the accumulator commitment by converting each key-value commitment of the plurality of key-value pairs of the accumulator commitment to a corresponding key-value commitment of the vector commitment; authenticating the second transaction using at least one property of the vector commitment to execute the multi-hop proof algorithm; and updating the accumulator commitment by adding a key-value pair to the accumulator commitment for the second transaction in response to verifying the second transaction based on the vector commitment.

Clause 12: The computer-implemented method of clause 10 or 11, wherein generating the vector commitment from the accumulator commitment extends at least one property of the accumulator commitment to include one or more properties of the vector commitment to operate on the plurality of key-value pairs, wherein the vector commitment increases in length to commit each key-value commitment stored by the accumulator commitment, and the increases in the length of the vector commitment comprise a plurality of keys that commit a domain of the accumulator commitment.

Clause 13: The computer-implemented method of any of clauses 10-12, further comprising: determining a current state of the blockchain network based on combining the accumulator commitment of a current block of the blockchain network with each previous accumulator commitment representing each previous block of the blockchain network, wherein a state of each previous block is determined by a commitment value of a key-value map stored for each previous block of the blockchain network, wherein the accumulator commitment includes a key-value map associated with the current state of the current block, wherein the current state of the blockchain network is determined by accumulating each accumulator commitment stored in each previous block of the blockchain network, wherein each new block in the blockchain network stores a reference back to a accumulator commitment of a previous block of the blockchain network, and wherein one or more key-value pairs of the accumulator commitment of the previous block comprises information that verifies at least one transaction of the current block.

Clause 14: The computer-implemented method of any of clauses 10-13, further comprising: transform each key-value pair of the plurality of key-value pairs of the accumulator commitment by: encode a plurality of keys of the plurality of key-value pairs into a probabilistic data structure by encoding the plurality of keys to include a test indicator that provides a signal in response to determining a specified key is in a set; and compress a plurality of values of the plurality of key-value pairs into a compact format that provides access to information associated with the plurality of values when compared to one or more test values.

Clause 15: The computer-implemented method of any of clauses 10-14, wherein encoding the plurality of keys using a probabilistic data structure comprises: generating a compact representation of the plurality of keys by hashing each key of the plurality of keys and resetting bits for each hashed key based on one or more resulting hash values, wherein the compact representation of the plurality of keys is configured to store the plurality of keys and information for querying the one or more key-value pairs.

Clause 16: The computer-implemented method of any of clauses 10-15, wherein the accumulator commitment is associated with a key-value map, wherein access to a plurality of values of the accumulator commitment is provided in response to a proof of knowledge determination of the key-value map for a key in the accumulator commitment, and wherein one or more blocks participate in transaction verification based only on commitment to a state without storing a current state of the blockchain network.

Clause 17: The computer-implemented method of any of clauses 10-16, wherein the state of each previous block in the blockchain network is cryptographically included in each subsequent block as a commitment to a previous state of the blockchain network.

Clause 18: The computer-implemented method of any of clauses 10-17, wherein each encoded key of a plurality of encoded keys of the accumulator commitment are each represented by a corresponding hexadecimal string based on the one or more key-value pairs and are compacted to between 2-bytes and 6-bytes.

Clause 19: A computer program product, comprising at least one non-transitory computer-readable medium including program instructions that, when executed by at least one processor, cause the at least one processor to: generate an accumulator commitment for a plurality of key-value pairs of a block in a blockchain network, the accumulator commitment cryptographically adding each key-value commitment of the block; obtain a new transaction for the block; determine a membership proof or non-membership proof to verify at least one accumulated value from one or more previous transactions; and authenticate the new transaction based on at least one proof to verify membership or non-membership based on the at least one accumulated value.

Clause 20: The computer program product of clause 19, wherein the at least one non-transitory computer-readable medium includes further program instructions that, when executed by at least one processor, cause the at least one processor to: determine a multi-hop proof for a plurality of transactions; generate a vector commitment from the accumulator commitment by converting each key-value commitment of the plurality of key-value pairs of the accumulator commitment to a corresponding key-value commitment of the vector commitment; authenticate at least one second transaction by using at least one property of the vector commitment to execute the multi-hop proof; and update the accumulator commitment by adding a key-value pair to the accumulator commitment for the second transaction in response to verifying the second transaction based on the vector commitment.

Clause 21: A system, comprising: at least one processor, configured to: generate a key-value commitment to a plurality of key-value pairs; determine a proof for a new transaction associated with a current block in a blockchain network based on an aggregation of transaction parameters from one or more previous transactions; verify the new transaction by authenticating the one or more previous transactions using a primitive of a vector commitment to solve the proof; and update the vector commitment by cryptographically adding a new key-value commitment to verify the new transaction.

Clause 22: The system of clause 21, wherein the at least one processor is further configured to: determine the proof for the new transaction comprises: generate a plurality of proofs, each of the plurality of proofs corresponding to an operation of the vector commitment, the plurality of proofs comprising at least one proof configured to verify a state transition in a blockchain due to an addition of the new transaction. aggregate the plurality of proofs into a batch; verify the plurality of proofs in the batch based on a single computation of the vector commitment; and generate a verification result based on verifying the plurality of proofs.

Clause 23: The system of clause 21 or 22, wherein the at least one processor is further configured to: generate an accumulator commitment from the vector commitment by converting each key-value pair of the plurality of key-value pairs of the vector commitment to a corresponding key-value pair of the accumulator commitment; and authenticate the new transaction by verifying membership or non-membership of the corresponding key-value pair in the accumulator commitment with at least one property of the accumulator commitment.

Clause 24: The system of any of clauses 21-23, wherein generating the accumulator commitment from the vector commitment extends the at least one property of the vector commitment to include one or more properties of the accumulator commitment for operating on a plurality of key-value commitments.

Clause 25: The system of any of clauses 21-24, wherein the at least one processor is further configured to: authenticate without revealing one or more intermediate state transitions or an entire key-value map of the blockchain network by using at least one primitive of the accumulator commitment to execute the proof to verify at least one of a signature, a proof of membership, a state of the vector commitment, or an amount associated with at least one transaction of the one or more previous transactions, and wherein the proof is a multi-hop proof algorithm.

Clause 26: The system of any of clauses 21-25, wherein the at least one processor is further configured to: determine a current state of the blockchain network based on combining the vector commitment of the current block of the blockchain network with each previous vector commitment representing each previous block of the blockchain network, wherein a state of each previous block is determined by a commitment value of a key-value map stored for each previous block of the blockchain network, wherein the vector commitment includes a key-value map associated with the current state of the current block, wherein the current state of the blockchain network is determined by aggregating each vector commitment stored in each previous block of the blockchain network, wherein each new block in the blockchain network stores a reference back to a vector commitment of a previous block of the blockchain network, and wherein one or more key-value pairs of the vector commitment of the previous block comprises information that verifies at least one transaction of the current block.

Clause 27: The system of any of clauses 21-26, wherein the at least one processor is further configured to: transform each key-value pair of the plurality of key-value pairs of the vector commitment; encode a plurality of keys of the plurality of key-value pairs into a probabilistic data structure by encoding the plurality of keys to include a test algorithm that provides a signal in response to determining a specified key is in a set; and compress a plurality of values of the plurality of key-value pairs into a compact format that provides access to information associated with the plurality of values when compared to one or more test values.

Clause 28: The system of any of clauses 21-27, wherein the at least one processor is further configured to: generate a compact representation of the plurality of keys by hashing each key of the plurality of keys and resetting bits for each hashed key based on one or more resulting hash values, wherein the compact representation of the plurality of keys is configured to store the plurality of keys and information for querying the one or more key-value pairs.

Clause 29: The system of any of clauses 21-28, wherein the vector commitment provides a key-value map, wherein access to a plurality of values of the vector commitment is provided in response to a proof of knowledge determination of the key-value map for a key in the vector commitment, and wherein one or more blocks participate in transaction verification based only on commitment to a state without storing a current state of the blockchain network.

Clause 30: The system of any of clauses 21-29, wherein the state of each previous block in the blockchain network is cryptographically accumulated in each subsequent header of each subsequent block as a vector commitment to a previous state of the blockchain network.

Clause 31: The system of any of clauses 21-30, wherein encoding the vector commitment comprises encoding the plurality of values directly as a linear function to form a linear combination of one or more vector elements, and wherein additions, updates, modifications, and/or deletions of values to the vector commitment are made by updating the linear function directly, and each encoded key of a plurality of encoded keys of the vector commitment are represented by a corresponding hexadecimal string based on the one or more key-value pairs and are compacted between 2-bytes and 6-bytes.

Clause 32: A computer-implemented method, comprising: generating a key-value commitment to a plurality of key-value pairs; determining a proof for a new transaction associated with a current block in a blockchain network based on an aggregation of transaction parameters from one or more previous transactions; verifying the new transaction by authenticating the one or more previous transactions using a primitive of a vector commitment to solve the proof; and updating the vector commitment by cryptographically adding a new key-value commitment to verify the new transaction.

Clause 33: The computer-implemented method of clause 32, wherein determining the proof for the new transaction comprises: determining the proof for the new transaction comprises: generating a plurality of proofs, each of the plurality of proofs corresponding to an operation of the vector commitment, the plurality of proofs comprising at least one proof configured to verify a state transition in a blockchain due to an addition of the new transaction; aggregating the plurality of proofs into a batch; verifying the plurality of proofs in the batch based on a single computation of the vector commitment; and generating a verification result based on verifying the plurality of proofs.

Clause 34: The computer-implemented method of clause 32 or 33, further comprising: generating an accumulator commitment from the vector commitment by converting each key-value pair of the plurality of key-value pairs of the vector commitment to a corresponding key-value pair of the accumulator commitment; and authenticating the new transaction by verifying membership or non-membership of the corresponding key-value pair in the accumulator commitment with at least one property of the accumulator commitment.

Clause 35: The computer-implemented method of any of clauses 32-34, wherein generating the accumulator commitment from the vector commitment extends the at least one property of the vector commitment to include one or more properties of the accumulator commitment for operating on a plurality of key-value commitments.

Clause 36: The computer-implemented method of any of clauses 32-35, wherein verifying the new transaction comprises: authenticating, by a validator node, the one or more previous transactions without revealing one or more intermediate state transitions or an entire key-value map of the blockchain network by using at least one primitive of the accumulator commitment to execute the proof to verify at least one of a signature, a proof of membership, a state of the vector commitment, or an amount associated with at least one transaction of the one or more previous transactions, and wherein the proof is a multi-hop proof algorithm.

Clause 37: The computer-implemented method of any of clauses 32-36, further comprising: determining a current state of the blockchain network based on combining the vector commitment of the current block of the blockchain network with each previous vector commitment representing each previous block of the blockchain network, wherein a state of each previous block is determined by a commitment value of a key-value map stored for each previous block of the blockchain network, wherein the vector commitment includes a key-value map associated with the current state of the current block, wherein the current state of the blockchain network is determined by aggregating each vector commitment stored in each previous block of the blockchain network, wherein each new block in the blockchain network stores a reference back to a vector commitment of a previous block of the blockchain network, and wherein one or more key-value pairs of the vector commitment of the previous block comprises information that verifies at least one transaction of the current block.

Clause 38: The computer-implemented method of any of clauses 32-37, further comprising: transforming each key-value pair of the plurality of key-value pairs of the vector commitment; encoding a plurality of keys of the plurality of key-value pairs into a probabilistic data structure by encoding the plurality of keys to include a test algorithm that provides a signal in response to determining a specified key is in a set; and compressing a plurality of values of the plurality of key-value pairs into a compact format that provides access to information associated with the plurality of values when compared to one or more test values.

Clause 39: A computer program product, comprising at least one non-transitory computer-readable medium including program instructions that, when executed by at least one processor, cause the at least one processor to: generate a key-value commitment to a plurality of key-value pairs; determine a proof for a new transaction associated with a current block in a blockchain network based on an aggregation of transaction parameters from one or more previous transactions; verify the new transaction by authenticating the one or more previous transactions using a primitive of a vector commitment to solve the proof; and update the vector commitment by cryptographically adding a new key-value commitment to verify the new transaction.

Clause 40: The computer program product of clause 39, wherein the at least one non-transitory computer-readable medium includes further program instructions that, when executed by at least one processor, cause the at least one processor to: generate a plurality of proofs, each of the plurality of proofs corresponding to an operation of the vector commitment, the plurality of proofs comprising at least one proof configured to verify a state transition in a blockchain due to an addition of the new transaction. aggregate the plurality of proofs into a batch; verify the plurality of proofs in the batch based on a single computation of the vector commitment; generate a verification result based on verifying the plurality of proofs. generate an accumulator commitment from the vector commitment by converting each key-value pair of the plurality of key-value pairs of the vector commitment to a corresponding key-value pair of the accumulator commitment; and authenticate the new transaction by verifying membership or non-membership of the corresponding key-value pair in the accumulator commitment with at least one property of the accumulator commitment.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a blockchain system for key-value commitments from accumulators and vector commitments according to some non-limiting embodiments or aspects;

FIG. 2 is a schematic diagram of a blockchain system implementing key-value commitments from accumulators and vector commitments according to some non-limiting embodiments or aspects;

FIG. 3 is a flow diagram of a method for key-value commitments from vector commitments according to some non-limiting embodiments or aspects;

FIG. 4 is a flow diagram of a method for key-value commitment from accumulator commitments according to some non-limiting embodiments or aspects; and

FIG. 5 illustrates example components of a device according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, sensors, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “node” or “blockchain node” may refer to one or more devices (e.g., computer, mobile phone, connected devices, etc.) that participates in a blockchain system (e.g., a participant in the blockchain network responsible for maintaining a copy of the ledger and participating in network activities, etc.). Nodes may perform various roles and take on responsibilities within the blockchain network (e.g., miners, validators, users, etc.). A node may maintain a copy of the entire blockchain network. A node validates transactions and contributes information to a consensus mechanism. Each node communicates with each of the other nodes in the blockchain system to propagate transactions, share updated information, determine consensus on the state of the blockchain, and/or the like. Multiple nodes collectively validate and add blocks to the blockchain network, ensuring the integrity and security of the blockchain system. A node may obtain or determine information about a blockchain network, such as, for example, determining the validity of transactions, the integrity of blocks, the condition of smart contracts, accounts, and/or the like. Such blockchain information may be used to provide the truth of a blockchain at a specific moment (e.g., the state of the blockchain represented at a specific point in time, etc.) as a reliable reference point for analysis, reconstruction, and/or the like.

As used herein, the term, “block” or a “block of a blockchain network” may refer to a component (e.g., an element of a blockchain, etc.). A block may include a data structure with transactions that have been added to the blockchain in a sequential manner. A block may comprise a batch or other logical grouping of valid transactions related to the block. Each block may include a link (e.g., a hash, cryptographic structure, and/or the like) pointing to a previous block. The link may create a chain of blocks (e.g., a blockchain, etc.). In some examples, a block comprises a number of transactions (e.g., multiple transactions, etc.) that may be validated by the network. Each block is validated before being added to the existing blockchain network. Each of the blocks organizes transactions and maintains a chronological record of each transaction that has occurred in the blockchain network.

As used herein, the term, “distributed ledger” may refer to a decentralized database maintained across multiple nodes in the network, forming the foundation for immutable and transparent record-keeping capabilities of blockchain systems. The decentralized database exists across multiple locations or among multiple participants of a blockchain network. Each participant or node in the network may include copy of the ledger. Changes to the ledger may be propagated to participants in a decentralized manner. The distributed ledger is formed by the chain of blocks containing transaction records. Each block may be linked to the previous one through cryptographic hashes, creating a chronological and immutable record of transactions. Each node in the blockchain network maintains a copy of the distributed ledger. This ensures redundancy and resilience, as the ledger is not stored in a single location and is not controlled by a central authority. Changes to the ledger, such as the addition of new transactions in a block, are synchronized across all nodes through a consensus mechanism. In some instances, consensus mechanisms, such as proof of work (PoW) or proof of stake, ensure that all nodes in the network agree on the validity of transactions and the state of the ledger. This consensus is reached through a process that involves the majority of participants in the network agreeing on the next valid block to be added to the chain.

As used herein, the term “primitive” may refer a fundamental cryptographic operation or building block used in the process of creating and verifying accumulator commitments or vector commitments. Specifically, these primitives include the operations and algorithms used for creating accumulator commitments or vector commitments, including cryptographic operations that combine multiple key-value pairs into a single, compact commitment, use hash functions and/or other cryptographic techniques to ensure the commitment is secure and efficient. Generating membership proofs that demonstrate a specific key-value pair is included in the accumulator commitment, including operations that derive the proof from the structure of the accumulator. Generating non-membership proofs: to show that a specific key-value pair is not included in the accumulator commitment, including cryptographic operations to efficiently verify the absence of a KVC without revealing other details about the accumulator's contents. Verifying proofs by checking the validity of the membership or non-membership proofs against the accumulator commitment to ensure that the proofs are correct and that the claimed key-value pairs are indeed included or excluded as stated. Verification of inclusion and proving that a key-value pair is part of the accumulated data. Verification of exclusion and proving that a key-value pair is not part of the accumulated data. Historical verification and checking accumulated values across multiple blocks, not just the current one.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that may be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, “public key encryption”, may refer to encoding a message to protect it from unwanted viewers by passing the message through a mathematical function (called a “cipher”) which uses a key to hide the original values in the message, and decoding the message depends on having the key that returns the values back to their original state, allowing the message to be read. In public key encryption (e.g., asymmetric encryption), the key that encodes the message and the one that decodes it are different (e.g., asymmetrical, etc.). It's called public key, because one key is made widely available (the “public key”) while the other is kept private (the “private key”) to ensure the security of the message. Public key encryption relies on private keys being kept secure, secret, and unavailable to those who may intercept, attack, or adulterate messages. Whether the public key is used to encrypt or verify the message depends on the nature of the message. For example, the private key is used to sign a message anyone may read, but cannot tamper with, at least without invalidating the signature. In cases where everyone is able to encrypt a message, but not open it (e.g., not able to be intercepted by the wrong person, etc.), it is encrypted with the public key, but only decrypted with the associated private key.

As used herein, “hashing” (e.g., a hash function), may refer to a method of cryptography that is designed to be irreversible. Hash functions are one-way algorithms, based on a mathematical function which takes an arbitrary input message and produces a deterministic output (e.g. a message digest). The one-way nature of the hash function, given a hashing output, makes it difficult to determine or guess the hashing input generating the hashing output. As used herein, hashing a message commonly serves one of two purposes, to protect the confidentiality of secret information (e.g. to validate the correctness of a password) or to confirm a message has been unmodified (e.g. to confirm the integrity of downloaded software). In the first case, when a message digest is created by hashing a message (e.g., a document, a number of data fields, etc.) for storage or transmission, in the event of an attack, all the hacker has stolen is unreadable, scrambled values (e.g., hash values, hash codes, digests, hashes, etc.). In the second case, message integrity may be determined, by hashing a copy of the original message and comparing the result to the original message's digest value. One does not need to read the message itself to determine that the message has not been modified, just need the output of hashing the message (e.g., message digest).

As used herein, satisfying a threshold may refer to a value (e.g., a score, a power consumption, etc.) being greater than the threshold, more than the threshold, higher than the threshold, greater than or equal to the threshold, less than the threshold, fewer than the threshold, lower than the threshold, less than or equal to the threshold, equal to the threshold, etc.

Existing blockchain systems are limited in growth by a number of resource intensive processes. For example, each of the blocks (e.g., each block of a blockchain network, ledger, etc.) participating in transaction validation store a complete state of the blockchain network (e.g., a complete ledger of the blockchain network, etc.) existing at the time of transaction (or when it is stored). In existing blockchain systems, storing the entire state of the blockchain network also requires availability of significant processing, storage and capacity resources. Additionally, as the blockchain network grows in size, and the number of transactions increases, storage of the state of each node may become a bottleneck for processing transactions.

Additionally, or alternatively, as a new block joins the blockchain network (or an existing block that previously moved offline returns back to online), existing blockchain systems may encounter issues when synchronizing the blockchain network. For example, each node of the blockchain system may synchronize a local state of the blockchain network (e.g., while operating on a current or active block with a state associated with each of the other blocks of the blockchain network, etc.). In existing blockchain systems, the synchronization process involves time-consuming and resource-intensive operations that must be performed for each node (e.g., downloading block information, verifying, storing, encrypting, etc.) to account for each block (e.g., each of a plurality of stored blocks, ledgers, ancestor/parent blocks, etc.).

Additionally, or alternatively, storing or synchronizing a blockchain network may include a significant impact on processing and communication of messages over network bandwidth. For example, synchronizing a local state with the rest of the blockchain network may require significant bandwidth usage and/or time. Additionally, transmitting a state (e.g., an entire state, etc.) of the ledger, especially in large-scale blockchain networks, may lead to decreased (e.g., slower, etc.) transaction propagation and increased network congestion.

Additionally, or alternatively, storing a blockchain network may include a significant impact on storage requirements. For example, when storing the entirety of a state of the blockchain network that includes each block, storage increases may result in greater storage costs. Storage costs may be especially high for nodes that include devices having limited resources or storage capacity.

Additionally, or alternatively, pruning and archiving nodes of a growing blockchain network may involve significant processing increases for both storage and communication. For example, in order to optimize storage usage, pruning and archiving may be used to reduce or eliminate unneeded or unwanted data from the blockchain network. Pruning may involve removing unnecessary or obsolete data from the blockchain to improve efficiency and reduce storage requirements. Archiving may involve storing historical data that is no longer actively used but may be needed for auditing, compliance, or other purposes. However, in existing systems that may be required to store an entire state, pruning and archiving may also change the integrity and consistency of the pruned data across the entire blockchain network. In this way, when data is pruned or archived, it can affect the integrity and consistency of the blockchain network. Additionally, pruned or archived data may no longer be available for verification, which can impact the integrity of the blockchain. Additionally, changes to the data structure resulting from pruning or archiving may lead to inconsistencies across the network, as some nodes may have access to different subsets of data than others.

Therefore, a blockchain system and network offering benefits in terms of scalability, synchronization, network efficiency, storage costs, and data management as in the current system and method is needed. By operating only on blocks that participate in transaction validation, the need to store the entire state of the ledger may be eliminated. The result is an improved blockchain network that provides more accessible, efficient, and scalable information for managing a blockchain.

Provided herein are improved systems, methods, and computer program products for a blockchain network with key-value commitments (KVC) generated from accumulator commitments (ACC) and/or vector commitments (VC). For example, as a blockchain grows in size and the number of transactions increase, accumulator commitments and VC maintain a stateless (e.g., a compressed representation of the state, etc.) blockchain network. This enables more efficient storage and scalability.

Additionally, or alternatively, a commitment to the state of each block of the blockchain network may be generated more accurately and efficiently with KVC from ACC and VC. In this way, a more accurate and efficient synchronization occurs as a new block joins the network (or an existing block moves offline, comes back online, etc.). Nodes may quickly synchronize with the entire blockchain network by obtaining a commitment to the state for efficiently verifying the state changes in each block of the blockchain network based on the novel primitives described in some non-limiting embodiments or aspects (e.g., a VC, an accumulator commitment, etc.).

Additionally, or alternatively, a commitment to the state of each block of the blockchain network eliminates a need to transmit the entire state of the blockchain network, such as, for example, to a central repository. This also eliminates a significant amount of bandwidth use and reduces a necessity for a significant amount of transmission data that would otherwise be needed for unnecessary transmissions. In this way, network efficiency is improved along with reducing bandwidth requirements.

Additionally, or alternatively, a blockchain network with KVC from accumulators and VC allows each block of the blockchain network to store only a commitment to the state that may be used to determine information about the blockchain. The commitment significantly reduces storage space requirements, and substantially reduces or eliminates the associated costs for storing the blockchain network.

Additionally, or alternatively, a blockchain network with KVC from accumulators and VC provide more accurate and efficient pruning and/or archiving of historical data while still maintaining commitments for verifying integrity of the blockchain. This enables nodes to participate in transaction validation without the need to store the entire state of the ledger for more accurate, accessible, efficient, and scalable communication.

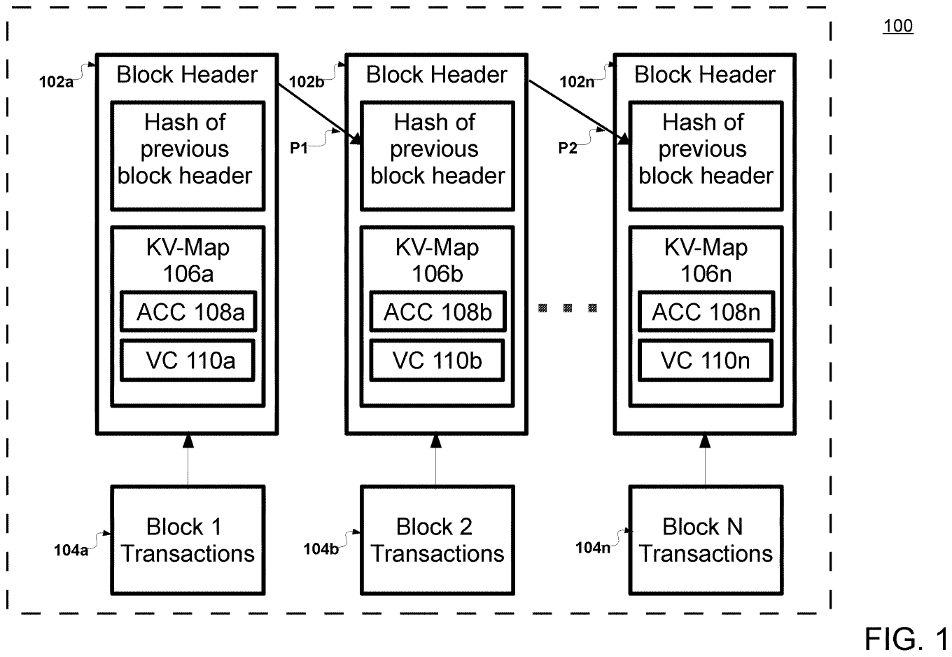

Referring now to FIG. 1, shown is a diagram of blockchain network 100 with KVC from accumulators and VC, according to some non-limiting embodiments or aspects. The blockchain network 100 provides a decentralized, distributed ledger that may be public or private. As shown in FIG. 1, blockchain network 100 includes first block 102a, second block 102b, and third block 102n (e.g., referred to collectively as blocks 102a-102n, list of blocks 102a-102n, etc.). Each of blocks 102a-102n, include a respective set of transactions 104a-104n.

In some non-limiting embodiments or aspects, blockchain network 100 is arranged so that the data is stored in blocks 102a-102n. In some examples, the data stored in the blocks 102a-102n may not be altered without the consensus of the entire blockchain network (e.g., each computer, device, system, and/or the like participating in the blockchain system, etc.).

In some non-limiting embodiments or aspects, for KVC, a key-value pair comprises a pair of data elements where the key may comprise a unique identifier and the value may comprise the associated data. The KVC allows for efficient and secure storage and retrieval of these key-value pairs, where a commitment value is computed based on the pairs and the party may later prove that a particular key-value pair was included in the commitment.

In some non-limiting embodiments or aspects, blocks 102a-102n include variables (e.g., one or more fields in a header, etc.) that store information about the location of a variable in another block. For example, blockchain network 100 may include P1, P2, and P3 which may link the list of blocks. For example, blockchain network 100 may include a sequence of blocks (102a, 102b, . . . 102n, etc.), where each of the blocks (e.g., 102a, 102b, . . . 102n) has specific data and links to the following block via a pointer, another structure, and/or the like. In FIG. 1, block 102a may point to a position of a variable in block 102b, and similarly, block 102b may point to a position of another variable in block 102c, and so on and so forth, until block 102n, which is the current block. Blocks 102a-102n form a chain of blocks which contain specific information (e.g., a blockchain, a distributed database, a distributed ledger, etc.).

In some non-limiting embodiments or aspects, first block 102a may not contain a pointer since it is the first in a chain. In some examples, there is a potential for a final block within a blockchain database that has a pointer with no value since the values for the block are not settled or complete.

In some non-limiting embodiments or aspects, a blockchain combines a secure group of blocks together into a network (e.g., peer-to-peer (“P2P”), etc.). The chain also provides decentralization to blockchain network 100. For example, blockchain network 100 is a combination of computers and blocks that are decentralized by linking to each other instead of a central server. The structure of blockchain network 100 is represented by the list of blocks 102a-102n with transactions in a particular order. In some examples, blocks 102a-102n may be stored as a flat file or in the form of a simple database.

In some non-limiting embodiments or aspects, a blockchain consists of a secure series of blocks organized into a network, as an example, operating on a peer-to-peer (P2P) basis. This chain of blocks ensures decentralization within blockchain network 100. Blockchain network 100 comprises interconnected computers and blocks, distributing authority across the network instead of relying on a central server. The structure of blockchain network 100 is delineated by a sequence of blocks (102a-102n) shown in FIG. 1. For example, each block includes transactions associated with blockchain network 100 and arranged in a specific order. Blocks 102a-102n may be stored as a flat file or within a simple database.

In some non-limiting embodiments or aspects, a key-value pair is stored in a KVC data structure that consists of a unique key and an associated value. The key is a unique identifier that is used to look up the value associated with it. This type of data structure is often used in programming languages, databases, and other systems to represent and manipulate data. For example, each record may be represented as a set of key-value pairs with each key corresponding to a field in the record and each value containing the data for that field.

In some non-limiting embodiments or aspects, a KVC in the blockchain network 100 provides a commitment (C) for a key-value pair (e.g. a key-value pair in KV-maps 106a, 106b, etc.) that may reveal (e.g., open, share, etc.) a commitment (C) for any specific key stored therein. In such an example, the KVC is concise for efficiency in storage and transmission. For example, the KVC reduces the size (e.g., cryptographically, etc.) of the commitment (C) for storing significantly less than the size of a key-value map. The KVC also is configured to receive and determine one or more updates to the KV-map 106a-106n, such as adding new key-value pairs or updating the value associated with an existing key. The KVC includes dynamic changes to the data while maintaining the integrity of a KVC.

In some non-limiting embodiments or aspects, KV map M (e.g., M⊆K×V) may comprise a collection of key-value pairs (k, v), such that K_{M} represents the set of keys for which values have been stored in the map M. The KVC may comprise a non-interactive primitive, such that, the KVC may be defined by specific algorithms that allow for the commitment to take place, as well as a later opening of the commitment (C) for any given key (e.g., specific keys may be later revealed or opened from the commitment, etc.) from which the associated value is obtained.

In some non-limiting embodiments or aspects, the KVC is configured to receive security parameters. In response to receiving the security parameters, the KVC produce correct proofs Λₖ for each of the keys k in the key set KM. For example, KVC obtains each of the one or more security parameters λ, one or more public parameters pp, the commitment (C) (e.g., obtained through a sequence of insert and update operations) to form a correctness requirement. In such an example, a key-value pair (k, v) is part of the map M, and then the verification algorithm Ver should output 1 with probability 1 when provided with C, (k, v), and the corresponding proof Λₖ.

In some non-limiting embodiments or aspects, a security requirement for KVC includes key binding that is computationally infeasible to attack for an adversary. For example, even with knowledge of the public parameters pp, to produce two different proofs for the same key or a proof for a key that has not been inserted, is computationally infeasible. In some examples, KVC restricts an adversary from executing the Insert operation more than once for any given key.

In some non-limiting embodiments or aspects, KVC comprises one or more membership proofs for ensuring integrity and authenticity of key-value mappings within blockchain network 100. The membership proofs include non-membership proofs which extend to a demonstration that a key k′ has not been inserted into the map. For example, the proofs comprise non-membership proofs (e.g., to prove non-membership, etc.), for updating non-membership proofs (e.g., a non-membership proof update), and verifying non-membership (e.g., KVC verification, etc.).

In some non-limiting embodiments or aspects, KVC is computed based on a set of key-value pairs, where each pair associates a unique key with a corresponding value. The commitment value C is derived from the entire set of key-value pairs, and the party may later prove that a particular key-value pair was included in the commitment without revealing the other pairs.

For example, in a hypothetical, Alice may want to commit to a set of key-value pairs (k1:v1, k2:v2, k3:v3). In such an example, Alice may compute a commitment value C based on these pairs using a cryptographic function such as a hash function. Alice may then publicly disclose the commitment value C without revealing the underlying key-value pairs.

Later, if Alice wants to prove that a particular key-value pair was included in the commitment, she can provide cryptographic proof that demonstrates that the key-value pair was one of the pairs used to compute the commitment value C. This proof may be verified by anyone without revealing the other pairs in the commitment.

In some non-limiting embodiments or aspects, KVCs allow for the efficient and secure storage and retrieval of sets of key-value pairs. A commitment value is computed based on the pairs, and the party can later prove that a particular key-value pair was included in the commitment. For example, blockchain network 100 includes first block 102a, second block 102b, and third block 102n (e.g., referred to collectively as blocks 102a-102n, list of blocks 102a-102n, etc.). Each of blocks 102a-102n include a respective set of transactions 104a-104n. As an example, to ensure the security and integrity of set of transactions 104a-104n of blockchain network 100, the key-value pairs stored in each of blocks 102a-102n must be accurate and free from tampering (e.g., not tampered with, etc.).

In some non-limiting embodiments or aspects, later, anyone who wants to verify the state of a particular account may use cryptographic proofs to ensure the integrity of the set of transactions 104a-104n in blocks 102a-102n by demonstrating that a specified key-value pair was included in the commitment value.

The integrity of blocks 102a-102n may be demonstrated for a specified key-value pair stored therein without revealing any other key-value pairs in the commitment. The commitment value represents the aggregated state of blockchain network 100 at a specific point in time. It serves as a summary or hash of all the data contained within blockchain network 100 up to that point. With cryptographic proofs, it becomes possible to verify the state of a particular account within blockchain network 100. This means that stakeholders may confirm the status or data associated with a specific account without needing to access all the information stored within blockchain network 100. This improves retrieval of key-value pairs and ensures the integrity of blockchain network 100 and for efficient and secure storage of the state of a transaction or account in blockchain network 100.

In some non-limiting embodiments or aspects, blockchain network 100 provides KV-maps 106a-106n comprising an accumulator of key-values for operating in an efficient and scalable blockchain network 100. In some non-limiting embodiments or aspects, other applications that require the storage and retrieval of large numbers of key-value pairs may also operate with the new accumulator for KVC.

In some non-limiting embodiments or aspects, one or more operations may be performed by KV-maps 106a-106n, including key generation, insertion of new key-value pairs, updating the commitment, updating proofs, and verification of commitments and proofs. KVC enables the secure and efficient generation and management of key-value mappings within a cryptographic framework.

In some non-limiting embodiments or aspects, key generation for KV-maps 106a-106n provides that: (pp, C)←$ KeyGen(1^{λ}). For example, key generation for KVC receives or obtains as input the security parameter λ and outputs public parameters pp. The key generation outputs public parameters pp that define the key and value spaces. The initial commitment (C) to the empty KV map. This algorithm generates the necessary cryptographic keys and parameters required for the commitment.

In some non-limiting embodiments or aspects, key insertion for KV-maps 106a-106n provides that: (C, Λₖ, upd)←Insert(C, (k, v)). For example, the key insertion, given a commitment string C and a key-value pair (k, v), outputs an updated commitment string C, and a proof Λₖ (e.g., a proof demonstrating that v is the value corresponding to k). Update information upd may also be included. The key insertion is operated to insert new KV pairs to the commitment while also generating proofs of correctness.

In some non-limiting embodiments or aspects, key update for KV-maps 106a-106n provides that: (C, upd)←Update(C, (k, δ)). For example, this KVC update represents the update algorithm, based on a commitment string C, a key k, and an update value δ. KVC update outputs an updated commitment string C and update information upd. In some examples, this KVC update does not require knowledge of the value corresponding to the key k, thereby providing or allowing for efficient updates to the commitment.

In some non-limiting embodiments or aspects, proof update for KV-maps 106a-106n provides that: Λₖ←ProofUpdate(k, Λk, upd). For example, the proof update obtains or receives a key k, a proof Λₖ for some value corresponding to k, and update information upd. Based on the input information, the proof update outputs an updated proof Λₖ. The proof update enables the updating of proofs to maintain correctness in the face of changes to the commitment.

In some non-limiting embodiments or aspects, correctness verifier for KV-maps 106a-106n provides that: 1/0←Ver(C, (k, v), Λₖ). In such an example, the correctness verifier receives a commitment string C, a key-value pair (k, v), and a proof Λₖ. The correctness verifier receives the inputs and generates outputs of either 1 (e.g., accept, etc.) or 0 (e.g., reject, etc.). This algorithm verifies the correctness of the commitment and the proof for a given key-value pair.

In some non-limiting embodiments or aspects, oblivious accumulators or accumulators refer to a cryptographic data structure to support membership queries and dynamic updates to KV-maps 106a-106n without requiring a trapdoor. As an example, accumulators, which are used to efficiently manage and verify membership in a set while supporting dynamic updates, may operate in a trapdoorless setting. For example, in a trapdoorless setting, there may be no secret information (e.g., a trapdoor, etc.) required for updates. In some examples, participants in blockchain network 100 may have or obtain equal access to update the accumulator.

In some non-limiting embodiments or aspects, updates to KV-maps 106a-106n may include accumulator commitments ACC 108a-108c. As an example, ACC 108a comprises oblivious accumulators that provide positive membership queries to efficiently and accurately determine whether an element belongs to the set represented by ACC 108a. Additionally or alternatively, ACC 108a-108n may support dynamic updates, allow for additions and deletions to the set without requiring a trapdoor for access, and/or the like.

In some non-limiting embodiments or aspects, updates to the ACC 108a-108n are additive. In such an example, modifying a value v by an amount δ involves changing v to v+δ. In some examples, updates to ACC 108a-108n may include incrementing or decrementing existing values rather than replacing them entirely.

In some non-limiting embodiments or aspects, updates to the ACC include setup, addition, deletion, commitment, membership proof creation, proof update, verification, and/or the like, for improvements which enable secure management of set membership with dynamic updates within blockchain network 100.

In some non-limiting embodiments or aspects, a setup for ACC 108a-108n is provided by a setup algorithm (e.g., Acc.Setup, etc.). For example, (pp,C₀)←Acc.Setup(1^{λ}) represents the setup algorithm. In this example, Acc.Setup obtains or receives the security parameter λ, and then outputs public parameters pp, which implicitly define the accumulator domain D, and the initial accumulator value C₀ for the empty set. Setup algorithm then initializes the accumulator with the necessary parameters for subsequent operations.

In some non-limiting embodiments or aspects, for addition, ACC 108a-108n provides an addition algorithm (e.g., Acc.Add, etc.). For example, (wₓ, u, aux)←Acc.Add(U, x) represents the addition algorithm. For such an example, given a set of the updates U={u} and an element x belonging to the accumulator domain D, addition algorithm outputs update information u. Additionally, addition algorithm generates a membership proof wₓ demonstrating that x is in the accumulator and auxiliary information aux.

In some non-limiting embodiments or aspects, for deletion, ACC 108a-108n provides a deletion algorithm (e.g., Acc.Del, etc.). For example, u←Acc.Del(U, x, aux) represents the deletion algorithm. In such an example, given a set of all updates U={u}, an element x belonging to the accumulator domain D, and auxiliary information aux. The ACC deletion algorithm outputs update information u. The deletion algorithm handles the removal of elements from the accumulator.

In some non-limiting embodiments or aspects, for commitment, ACC 108a-108n provides a commitment algorithm (e.g., Acc.Commit, etc.). For example, C←Acc.Commit (U) represents the commit algorithm. For example, given a set of all updates U={u}, commitment algorithm returns the accumulator value C. If all elements are added by the same entity, the set U may be viewed as {x, aux}.

In some non-limiting embodiments or aspects, addition for ACC 108a-108n provides a membership proof creation algorithm (e.g., Acc.WitCreate, etc.). For example, wₓ←Acc.WitCreate (U, aux) represents the witness creation algorithm. In such an example, given a set of all updates U={u} and auxiliary information aux for an element x, membership proof creation algorithm outputs a membership proof wₓ demonstrating that x is in the accumulator. The membership proof creation algorithm may create proofs for elements at any point in time, not necessarily during their addition.

In some non-limiting embodiments or aspects, addition for ACC 108a-108n provides a membership proof update algorithm (e.g., Acc.WitUpdate, etc.). For example, w′ₓ←Acc.WitUpdate (wₓ, u): The membership proof update algorithm represents the witness update algorithm. For example, given a membership proof wₓ and update information u, it outputs an updated membership proof w′ₓ. The membership proof update algorithm allows for updating proofs to maintain correctness in the face of changes to the accumulator.

In some non-limiting embodiments or aspects, addition for ACC 108a-108n provides a verification algorithm (e.g., Acc.Ver, etc.). For example, 0/1←Acc.Ver(C, x, wₓ): This verification algorithm represents the verification algorithm. For example, given an accumulator value C, an element x belonging to the accumulator domain D, and a membership proof wₓ, it outputs either 1 (accept) or 0 (reject). The verification algorithm verifies the correctness of the membership proof for the given element and accumulator value.

In some non-limiting embodiments or aspects, input for the commitment algorithm (e.g., Acc.Commit, etc.) includes the set of updates U rather than the set of elements X. Accordingly, instead of directly providing the elements that have been added to or removed from the accumulator, the algorithm receives a set of updates that encapsulates these changes.

In some non-limiting embodiments or aspects, the deletion algorithm (e.g., Acc.Del) and the witness creation algorithm (e.g., Acc.WitCreate, etc.) both take as input the auxiliary information aux. Accordingly, while anyone may add elements to the accumulator, only the entity that originally added an element can perform deletion or prove membership for that element. The use of auxiliary information aux in the deletion and witness creation algorithms forms an ownership or control over the elements added to the accumulator. Accordingly, entities are ensured to have the ability to add elements but can only delete their own additions or prove membership for their own elements. By allowing only the entity that performed the addition to delete elements or prove membership, blockchain network 100 maintains accountability and prevents unauthorized removal or manipulation of elements and contributing to security and integrity of the accumulator within the blockchain network (e.g., the cryptographic framework, etc.).

In some non-limiting embodiments or aspects, for any set X of elements in D and x∈X, correctness guarantees that Acc.Ver (C, x, wₓ) will output 1 for C being the output of accumulator commitment and wₓ being the output of accumulator witness create. For example, the verification algorithm, where C is the accumulator value, x is the element being verified, and wₓ is the membership proof for x. If the verification algorithm outputs 1, this may signal that x is a member of the set ensuring correctness.

In some non-limiting embodiments or aspects, membership soundness guarantees that a malicious entity that picks a set X cannot give a valid proof w_{y} for y not in X. For example, membership soundness represents the probability that a probabilistic polynomial-time (PPT) adversary may produce a valid proof for an element that is not in the set. If the probability is negligible, it ensures soundness. For example, for any PPT adversary A, the following holds:

$$Pr [ \begin{matrix}pp ← Acc . Setup ( {1}^{λ} ) \\ {C}_{0} ← Acc . Commit ( ∅ ) \\ [ y , X = \{ x , aux \} , {w}_{y} ← \text{?} ( pp , {C}_{0} ) ] \\ C ← Acc . Commit ( \{ x , aux \} ) \\ return Acc . Ver ( C , y , {w}_{y} ) ∧ y ∉ X\end{matrix} ] \leq negl ( λ )$$

In such an example, the probability that a PPT adversary may produce a valid proof w_{y} for an element y that is not in the set X. If the probability is negligible (≤negl(λ)), ensures membership soundness.

In some non-limiting embodiments or aspects, element hiding guarantees that a malicious entity that picks two elements in D cannot guess which one was added and then deleted given the updates and the accumulator value changes. For any PPT adversary A, the following holds:

$$Pr [ \begin{matrix}pp ← Acc . Setup ( {1}^{λ} ) \\ {C}_{0} ← Acc . [ Commit ( ∅ ) \\ {x}_{0} , {x}_{1} ← \text{?} ( pp , {C}_{0} ) \\ b ← \{ 0 , 1 \} \\ ( {w}_{{x}_{b}} , u ) Acc . Add ( ∅ , {x}_{b} ) \\ {u}^{′} ← Acc . Del ( u , {x}_{b} ) \\ {b}^{′} ← \text{?} ( pp , {C}_{0} , u , {u}^{′} ) \\ {returnb}^{′} = b\end{matrix} ] \leq \frac{1}{2} + negl ( λ )$$

In such an example, the probability is determined, such that a PPT adversary may correctly guess which of two elements was added and then deleted from the accumulator. If the probability is at most equal to:

$$\frac{1}{2} + negl ( λ ) ,$$

this may indicate that the adversary's ability to distinguish is not significantly better than random chance.

In some non-limiting embodiments or aspects, add-delete indistinguishability guarantees that a malicious entity cannot guess whether an element x in the accumulator was deleted or a new element was added given the updates and the accumulator value changes. For any PPT adversary A, the following holds:

$$Pr [ \begin{matrix}pp ← Acc . Setup ( {1}^{λ} ) \\ {C}_{0} ← Acc . Commit ( X = ∅ ) \\ x {←}^{\$} D \\ ( {w}_{x} , u ) ← Acc . Add ( U = ∅ , x ) \\ b {←}^{\$} \{ 0 , 1 \} \\ if b = 0 : {x}^{′} {←}^{\$} 𝒟 , X = X ⋃ \{ {x}^{′} \} , ( {w}_{{x}^{′}} , {u}^{′} ) ← Acc . Add ( U , x ) , U = U ⋃ {u}^{′} \\ if b = 1 : X = X \backslash \{ x \} , {u}^{′} ← Acc . Del ( U , x ) , U = U ⋃ {u}^{′} \\ {b}^{′} ← \text{?} ( pp , {C}_{0} , U ) \\ return {b}^{′} = b\end{matrix} ] \leq \frac{1}{2} + negl ( λ )$$

In such an example, the probability is determined such that a PPT adversary may correctly guess whether an element in the accumulator was added or deleted based on accumulator value changes and updates. If the probability is at most equal to:

$$\frac{1}{2} + negl ( λ ) ,$$

this indicates that the adversary's ability to distinguish is not significantly better than using random chance.

In some non-limiting embodiments or aspects, add-delete unlinkability guarantees that a malicious entity that picks two elements in D cannot guess which one was deleted given the updates and the accumulator value changes. For any PPT adversary [symbol] , the following holds:

$$Pr [ \begin{matrix}pp ← Acc . Setup ( {1}^{λ} ) \\ {C}_{0} ← Acc . Commit ( X = ∅ ) \\ {x}_{0} , {x}_{1} ← \text{?} ( pp , {C}_{0} ) \\ ( {w}_{{x}_{0}} , {u}_{1} ) ← Acc . Add ( ∅ , {x}_{0} ) \\ ( {w}_{{x}_{1}} , {u}_{2} ) ← Acc . Add ( \{ {u}_{1} \} , {x}_{1} ) \\ b {←}^{\$} \{ 0 , 1 \} \\ {u}_{3} ← Acc . Del ( \{ {u}_{1} , {u}_{2} \} , {x}_{b} ) \\ {u}_{4} ← Acc . Del ( \{ {u}_{1} , {u}_{2} , {u}_{3} \} , {x}_{1 - b} ) \\ {b}^{′} ← \text{?} ( pp , {C}_{0} , {u}_{1} , {u}_{2} , {u}_{3} , {u}_{4} ) \\ {returnb}^{′} = b\end{matrix} ] ) ] \leq \frac{1}{2} + negl ( λ )$$

In some non-limiting embodiments or aspects, the above represents the probability that a PPT adversary may correctly guess which of two elements was added and then deleted from the accumulator. If the probability is at most

$$\frac{1}{2} + negl ( λ ) ,$$

this indicates that the adversary's ability to distinguish is not significantly better than random chance.

In some non-limiting embodiments or aspects, the following functionality of the accumulators (e.g., ACC 108a, 108b . . . 108n) is provided. Accumulators 108a-108n may provide a cryptographic primitive used to aggregate and maintain a set of elements such that one may efficiently prove membership or non-membership of an element in the set. Accumulators 108a-108n provide operations for adding, deleting, and committing elements to the accumulator, as well as generating and updating membership witnesses.

In some non-limiting embodiments or aspects, accumulators 108a-108n are set (e.g., input, initialized, etc.) by accumulator setup algorithm (e.g., Acc.Setup (1^{λ})) which interfaces and coordinates with KV-maps 106a-106n, to execute KVC.KeyGen. For example, the accumulator setup algorithm initializes parameters required for the accumulator. As an example, accumulator setup algorithm first runs the KVC.KeyGen function with the security parameter (1^{λ}) to obtain public parameters (pp) and an initial commitment (C₀) for the KVC. The accumulator setup algorithm then defines H₁, H₂: {0,1}*× [symbol] → [symbol] , where [symbol] is the key domain of the KVC. In some examples, hash functions are defined to map elements to keys in the KVC key domain. These hash functions are typically defined to map elements to keys in the KVC key domain.

In some non-limiting embodiments or aspects, an accumulator addition algorithm (e.g., Acc.Add) intakes an element x and adds it to the accumulator, generating the necessary proofs and updating information in the process. For example, accumulator addition algorithm first selects a random value r. Accumulator addition algorithm then computes a key k based on the randomness r and the input value x using a hash function H₁.

In some non-limiting embodiments or aspects, accumulator addition algorithm inserts the key-value pair (k, 1)) into the commitment C using the KVC. Insert operation. The accumulator addition algorithm generates a new commitment C and a proof Λₖ, and also provides update information u. After the insertion, the accumulator addition algorithm releases the update information u. It then sets auxiliary information aux to associate the value x with the randomness r. Finally, the accumulator addition algorithm provides a witness wₓ based on the proofs generated during the insertion process. The witness includes the proof (Λ_{H}_{₁}_{(r,x)}) associated with the hash of r and x, as well as another proof (Λ_{H}_{₁}_{(r,x)}) that is derived from additional processing involving r and x. The witness wₓ contains information necessary to verify the presence of x in the accumulator. For example, Acc.Add picks a random r and computes k (e.g., sets k←H₁(r, x)), computes (C, Λₖ, u)←KVC. Insert (C, (k, 1)), releases u and sets aux=(x, r). In addition, wₓ is set to (Λ_{H}_{₁}_{(r,x)}, Λ̅_̅{̅H̅}̅_̅{̅₂̅}̅_̅{̅(̅r̅,̅x̅)̅}̅)̅. Then to insert the key-value pair into the commitment, executes KVC. Insert, releases update information, sets auxiliary information, and sets a witness.

In some non-limiting embodiments or aspects, accumulator delete (e.g., Acc.Del, etc.) first parses the auxiliary information aux, which is assumed to be in the form (x, r). This indicates that x is associated with randomness r. Based on the parsed auxiliary information (x, r), accumulator delete computes a key k using a hash function H₂. Accumulator delete then executes the KVC. Insert operation to insert the key-value pair (k, 1) into the commitment C. This operation generates a new commitment C, a proof Λₖ, and update information u. After the insertion, the function releases the update information u. Overall, Acc.Del removes an element x from the accumulator by computing the appropriate key k, inserting it into the commitment using the KVC. Insert operation and releasing the update information u.

In some non-limiting embodiments or aspects, for each update u in the set U, the accumulator commit algorithm (e.g., Acc.Commit) parses U to extract key-value pairs (k, v). Then, accumulator commit algorithm executes the KVC. Insert operation for each pair (k,v) to update the commitment C accordingly. After processing all updates, accumulator commit algorithm returns the resulting commitment C.

In some non-limiting embodiments or aspects, a witness create algorithm (e.g., Acc.WitCreate) generates a witness for the element x based on the given set of updates U and the auxiliary information aux, which is assumed to contain the pair (x,r). For each update u in U that does not involve x, the witness create algorithm parses U to extract key-value pairs (k, v) and executes the KVC. Insert operation to update the commitment C accordingly. For the update involving x, the function parses the auxiliary information aux to obtain the pair (x, r). Then, it computes a key k based on r and x using the hash function H₁. After that, it executes the KVC. Insert operation to insert the key k and the value 1 into the commitment C. In some examples, the witness create algorithm sets the witness wx to be the pair of proofs Λ_{H}_{₁}_{(r,x)}, Λ_{H}_{₂}_{(r,x)} generated during the insertion of k and Λ_{H}_{₁}_{(r,x)}, Λ_{H}_{₁}_{(r,x)} is the proof corresponding to k generated during the insertion of x.

In some non-limiting embodiments or aspects, a witness update algorithm (e.g., Acc.WitUpdate) updates a witness wx with new information u. For example, witness update algorithm receives the existing witness wx and the update information uu as inputs. Witness update algorithm then updates the witness wx′ using the update information u and the existing proofs stored in wx. To update the proofs in wx, it calls the KVC. ProofUpdate operation for both hash functions H₁ and H₂ with their respective parameters and existing proofs along with the update information u. The resulting updated witness wx′ comprises the updated proofs for both hash functions. The function checks the validity of the updated witness using the verification algorithms provided by the KVC. In this way, Acc.WitUpdate updates the witness wx with new information u by updating the proofs associated with the hash functions H₁ and H₂ using the ProofUpdate operation provided by the KVC and then verifies the updated witness's validity.

In some non-limiting embodiments or aspects, accumulator verifier checks the validity of the witness Λₓ associated with the element x in the accumulator C using the verification algorithms provided by the KVC for both hash functions H₁ and H₂. For example, accumulator verifier (e.g., Acc.Ver) receives as input the accumulator value C, the element x and its associated randomness r, and the witness Λₓ. The function decomposes Λₓ into proofs associated with two hash functions: Λ_{H}_{₁}_{(r,x)} and Λ_{H}_{₂}_{(r,x)}. It then checks the validity of the two proofs using the verification algorithms provided by the KVC:

For the first hash function H₁, it verifies Λ_{H}_{₁}_{(r,x)} against the commitment C and the hashed value H₁(r, x) along with the value 1.

For the second hash function H₂, it verifies Λ_{H}_{₂}_{(r,x)} against the commitment C and the hashed value H₂(r, x).

If both verifications succeed, Acc.Ver returns 1 (to accept) indicating that the witness is valid. Otherwise, it returns 0 (reject).

In some non-limiting embodiments or aspects, the KVC map and the ACC 108a-108n (e.g., accumulator commitment) are related by the KVC map. For example, the KVC map is a structure that stores key-value pairs (k, v) where k is the key and v is the corresponding value. The KVC map is represented by a commitment string C that encapsulates the state of the KVC map after performing various operations like insertion and updates.

The accumulator commitment is another cryptographic primitive used to generate commitments to sets of updates (U, x) where U represents the set of all updates and x is an element being added or deleted. The accumulator interfaces with the KVC map when generating commitments and proofs for key-value pairs. For example, in operations like addition (Acc.Add) and deletion (Acc.Del), the accumulator generates proofs and update tokens based on elements inserted or deleted. These elements are typically derived from the key-value pairs stored in the KVC map. The accumulator's commitment and proof generation procedures utilize hashing functions that are defined based on the KVC map's key-value domain and the element being added or deleted. In this way, KV-maps 106a-106n and ACC 108a-108n together provide cryptographic functionalities such as commitment, proof generation, and verification for key-value pairs and updates.

In some non-limiting embodiments or aspects, the following functionality of the VC 110a-110n (e.g., VC 110a, 110b . . . 110n) is provided. VC 110a-110n may provide a cryptographic primitive used to aggregate and maintain a set of elements such that one may efficiently prove membership or non-membership of an element in the set. VC 110a-110n provide operations for adding, deleting, and committing elements to the KVC, as well as generating and updating membership witnesses.

In some non-limiting embodiments or aspects, one or more operations provide KeyGen (Key Generation). The KeyGen operation generates the public parameters (pp) for the VC. It takes as input the security parameter λλ and the length of vectors q. The output of KeyGen is the public parameters pp, which are used in subsequent operations of the VC.

In some non-limiting embodiments or aspects, KeyGen initializes the VC by generating public parameters pp, which are necessary for the initialization. These public parameters pp are typically used throughout the execution of the to perform commitments, openings, and other operations.

In some non-limiting embodiments or aspects, the accumulator activates one or more operations or primitives of VC to handle dynamic key-value pairs while maintaining efficient proof and update mechanisms.

In some non-limiting embodiments or aspects, the accumulator activates one or more operations or primitives of VC to handle Key Generation: (pp, C)←KV·Key Gen(1^{λ}), K, V∈pp initializes the key-value accumulator commitment (KVAC). Runs VC.Key Gen (1^{λ}, 1) to get parameters for a vector of length 1. VC. Commitₚₚ(0) is used to get initial commitments Cₖ and Cᵥ. The accumulator leverages a VC to build a KVAC. The improvement is that it inherits the efficient properties of VCs, including the ability to handle updates and proofs efficiently.

In some non-limiting embodiments or aspects, the accumulator activates one or more operations or primitives of VC to handle Insertion: (C, Λₖ, u)←KV.Insert (C, (k, v)). Extend Length(pp, q) is executed to extend the parameters for the vector length to q+1 Initializes position (pos) q+1 of the vectors Cₖ and Cᵥ with 0. Runs VC.Updateₚₚ(Cₖ, 0, k, q+1) and VC.Updateₚₚ(Cᵥ, 0, v, q+1). Sets Λₖ to be the VC proof (Cₖ·Λ_{q+1}, Cᵥ·Λ_{q+1}). Stores auxiliary data aux as (k, pos=q+1). Releases u=(k, v). The Extend Length function handles dynamic sizes by updating the commitment parameters to accommodate additional elements. The KVAC initialization by generating a small initial VC and setting up the initial commitments for keys and values. Insertion involves extending the vector to accommodate new key-value pairs and updating the commitments accordingly. The process ensures that the new entries are correctly incorporated into the vector commitment.

In some non-limiting embodiments or aspects, the accumulator activates one or more operations or primitives of VC to handle Verification:

$$\frac{0}{1} ← K V .$$

Ver(C, (k, v), Λₖ): Outputs the logical AND of VC.Verₚₚ(Cₖ, k, pos, Λₚₒₛ) and VC.Verₚₚ(Cy, v, pos, Λₚₒₛ). Verification checks that a given key-value pair is correctly committed by checking the proofs against the current state of the VC for keys and values. When the data is updated, the proofs must also be updated to remain valid. by adjusting the proofs based on the changes in the committed data.

In some non-limiting embodiments or aspects, the accumulator activates one or more operations or primitives of VC to handle Proof Update: Λ′ₖ←KV.ProofUpdate (k, Λₖ, u): Runs VC.ProofUpdate eₚₚ(Cₖ, Λₚₒₛ, k′, pos, u=(k′, v′)) and VC.ProofUpdateₚₚ(Cᵥ, Λₚₒₛ, v′, pos, (k′, v′)).

In some non-limiting embodiments or aspects, the accumulator activates one or more operations or primitives of VC to inherit all the properties of the VC, such as multi-hop aggregation. In some non-limiting embodiments or aspects, for support of key non-membership, accumulator commitment proves that a key is not part of the set.

In some non-limiting embodiments or aspects, a VC is a cryptographic primitive. A VC allows for efficient and compact representation of a vector of data elements typically represented as a list or an array and provides efficient proofs of the existence or non-existence of a data element at a specific position (POS) in the vector. It is particularly useful when dealing with large sets of data elements that may be frequently updated or accessed in a random or dynamic manner. A VC may include the following:

In some non-limiting embodiments or aspects, KVC key-binding refers to the property of a KVC such that the commitments generated by the VC are bound to the keys and values they represent. In such an example, a commitment is made to a certain key-value pair, and it should not be possible for an adversary to produce fake proofs or alter the key-value mappings without being detected.

As an example, KVC key-binding is formalized through a game between a challenger and an adversary, where the adversary tries to manipulate the commitments and proofs produced by the KVC. The goal of this game is to ensure that even if the adversary has access to the public parameters of the KVC and may make certain queries to the challenger, they cannot produce fake proofs with a non-negligible probability.

In some non-limiting embodiments or aspects, KVC key-binding ensures the integrity and authenticity of the commitments in a KVC, preventing unauthorized modifications or forgeries. For a KVC and an adversary A, a random variable is defined as

$${G}_{KVC , λ , A}^{bind}$$

through a game between a challenger CH and A as follows:

$${G}_{KVC , λ , {A}^{bind}}^{bind}$$

First, CH samples (pp, C)←$KeyGen(1^{λ}) and sends them to A. CH also maintains its own state comprising a key-value map M⊆K×V initialized to the empty map and the initial commitment value C.

Next, A issues queries in one of the following forms:
(Insert, (k, v)): CH checks if M contains a tuple of the form (k,·). If so, CH responds with ⊥. If not, CH updates M to M∪{(k, v)} and executes Insert (C, (k, v)) to obtain a new commitment C.
(Update, (k, δ)): CH checks if M contains a tuple of the form (k, v). If not, CH responds with ⊥. If so, CH updates M to (M∪{(k, v+δ)})\{(k, v)} and executes Update (C, (k, δ)) to obtain a new commitment C.

A then sends a final output to CH of one of the following forms:
Type 1: a key k such that M does not contain a tuple of the form (k,·), a value v, and a proof Λₖ.
Type 2: a key k such that M contains a tuple of the form (k,·), a pair of values (v, v′) where v≠v′, and a pair of proofs

$$( {Λ}_{k} , {Λ}_{k}^{′} ) .$$

CH then performs the following checks corresponding to A's output:
Type 1: if Ver (C, (k, v), Λₖ)=1, then CH outputs failure. Otherwise, CH outputs success.
Type 2: if

$$Ver ( C , ( k , v ) , {Λ}_{k} ) = Ver ( C , ( k , {v}^{′} ) , {Λ}_{k}^{′} ) = 1 ,$$

then CH outputs failure. Otherwise, CH outputs success.

The value of the random variable

$${G}_{KVC , λ , A}^{bind}$$

is defined to be the output of CH, namely, failure or success.

In some non-limiting embodiments or aspects, a KVC is key-binding if for every PPT adversary [symbol] , the following probability is negligible in λ:

$${Adv}_{KVC , 𝒜}^{bind} ( λ ) = Pr [ failure ← {\$𝒢}_{KVC , λ , 𝒜}^{bind} ] .$$

For example, in the definition of [symbol] , the commitment C is honestly generated by the challenger CH based on the queries issued by the adversary [symbol] . Also, the definition only uses the Insert and Update routines of the KVC, as these are the only two that impact the value of the commitment. The adversary may perform all operations by itself given the public parameters. However, the purpose of the game is to define the honestly generated commitment with respect to which the adversary will attempt to produce “fake” proofs.

In some non-limiting embodiments or aspects, no PPT adversary will be able to produce “fake” proofs. The KVC are not required to satisfy any sort of hiding property, although one may also define KVC that are hiding. Informally, a KVC is hiding if an adversary cannot distinguish whether a commitment was created to a key-value map M or to another key-value map M′ even after learning the values corresponding to keys that have the same value in both maps. Accordingly, a KVC is considered key-binding if no adversary that runs in probabilistic polynomial time (PPT) may produce fake proofs successfully with a non-negligible probability.

In some non-limiting embodiments or aspects, there is no inherent requirement for KVC to conceal the relationship between keys and values. However, KVC that do offer hiding properties may be configured or programmed. Specifically, a KVC is considered hiding if even after an adversary learns the values corresponding to keys that have the same value in two different maps, they cannot distinguish which map the commitment was created for. In such an example, hiding ensures that the commitment reveals minimal information about the underlying data structure.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of blockchain 100 may perform one or more functions described as being performed by another set of systems or another set of devices of system 100.

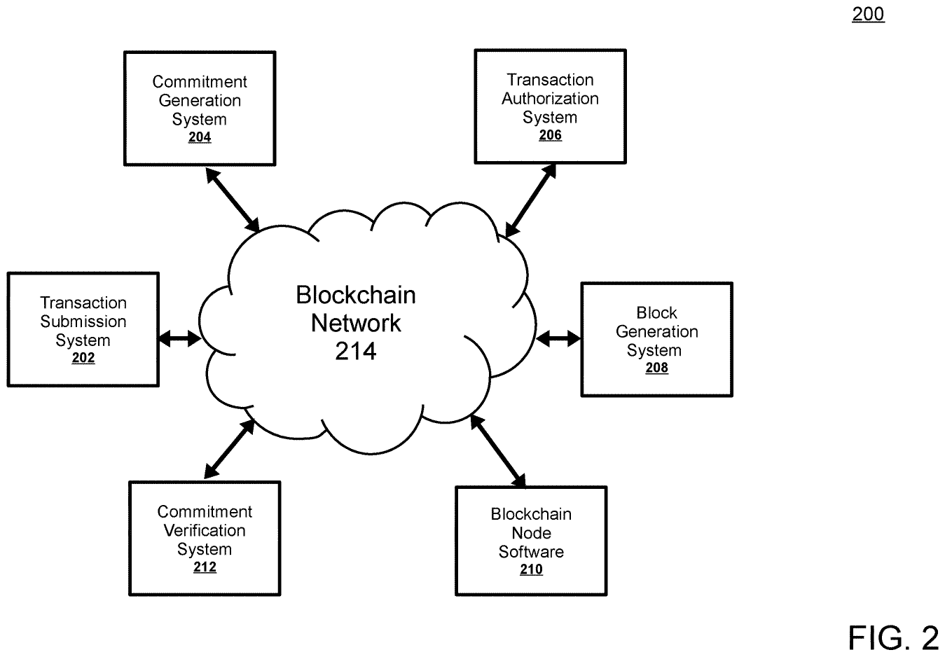

Referring now to FIG. 2, shown is a diagram of an example blockchain system 200 comprising KVCs from accumulators and/or VC, according to some non-limiting embodiments or aspects. Blockchain system 200 provides a decentralized, distributed ledger that may be public or private.

As shown in FIG. 2, blockchain system 200 includes transaction submission system 202, commitment generation system 204, transaction authorization system 206, block generation system 208, blockchain node software 210, and commitment verification system 212. The systems and software of the blockchain network together create and maintain a secure and transparent blockchain network 100 as shown in FIG. 1, which allows users to create and validate transactions with KVCs from accumulators and VC.

In blockchain system 200, the state of the system is represented as a set of key-value pairs where the keys represent the unique addresses of user accounts and the values represent the balance or state of each account. These key-value pairs are stored in a distributed data structure of blockchain network 100, a continuously growing list of blocks that are linked together using cryptographic hashes.

In some non-limiting embodiments or aspects, transaction submission system 202 provides a user interface (UI). For example, transaction submission system 202 may include one or more devices capable of providing a UI to users. For example, transaction submission system 202 provides a UI for creating blockchain transactions. In another example, transaction submission system 202 executes a UI to users to submit each new transaction or a group of transactions to blockchain network 100. In some examples, transaction submission system 202 may be a simple command-line interface or a more complex web-based application.

In some non-limiting embodiments or aspects, commitment generation system 204 generates or creates a commitment to the state of blockchain network 100. For example, at a particular point in time, commitment generation system 204 may include one or more devices capable of creating a commitment to the state of blockchain network 100. In some examples, commitment generation system 204 generates a snapshot memorializing the state of blockchain network 100. Commitment generation system 204 may be part of blockchain node software 210 or a part of a separate system that is run by one or more validator nodes. In blockchain system 200, commitment generation system 204 generates a commitment value that is computed based on the current set of key-value pairs using a cryptographic function such as a hash function. This commitment value is then stored in blockchain network 100 along with transaction data.

In some non-limiting embodiments or aspects, transaction authorization system 206, blockchain node software 210, and/or the like, may include one or more devices capable of verifying new transactions before they are added to blockchain network 100. Transaction authorization system 206 may be part of blockchain node software 210 or a part of a separate system that is run by one or more validator nodes.

In some non-limiting embodiments or aspects, block generation system 208 may include one or more devices capable of creating new blocks in blockchain network 100. Block generation system 208 may include a consensus algorithm to ensure that each of one or more validator nodes agree (e.g., reach consensus about the next block to be added to the blockchain network 100 of FIG. 1).

In some non-limiting embodiments or aspects, blockchain node software 210 may include one or more devices capable of creating and verifying transactions. In addition, blockchain node software 210 may include one or more devices capable of creating new blocks. Blockchain node software 210 may include one or more devices capable of communicating with other nodes in blockchain network 100.

In some non-limiting embodiments or aspects, commitment verification system 212 may include one or more devices capable of verifying a commitment to the state of blockchain network 100. Commitment verification system 212 may be part of the operating system for blockchain node software 210 or a separate system that is run by validator nodes.

In some non-limiting embodiments or aspects, commitment generation system 204 may determine the KVC (e.g., accumulator commitment, vector commitment, KVC, etc.) based on a set of cryptographic primitives, including pseudorandom functions, collision-resistant hash functions, and commitments. Commitment generation system 204 may provide primitives to enable efficient and secure storage and retrieval of key-value pairs, while also supporting advanced features including dynamic updates, compact proofs, and authenticated queries. Commitment verification system 212 may determine that a KVC may achieve high performance and scalability while maintaining strong security guarantees. In blockchain network 100 shown in FIG. 1, the primitives may be used to operate on a tuple (e.g., a representation of a key-value pair that a party may desire to add, update, delete, etc.) to the map. For example, if blockchain network 100 is used to store transactions, the tuple could represent a transaction where the key is the transaction ID, and the value is the transaction details.

In some non-limiting embodiments or aspects, an accumulator and a VC may be provided, generated, used in combination for certain blockchain systems to achieve specific properties and functionalities. In some non-limiting embodiments or aspects, only one of an accumulator or a VC may be provided, generated, or used in combination for certain blockchain systems to achieve specific properties and functionalities.

In some non-limiting embodiments or aspects, an accumulator is a data structure that accumulates the commitments of key-value pairs into a single value. It allows for efficient and compact representation of a large number of key-value pairs (e.g., key-value pairs for transactions, state updates, etc.) in a single value. The accumulator may be updated with new commitments as new data elements are added to blockchain network 100 and may be used to efficiently verify the membership or non-membership of a specific data element in the accumulated set. An accumulator commitment may include the following:

In some non-limiting embodiments or aspects, the combination of an accumulator and a VC may provide certain benefits in blockchain system 200. For example, the accumulator may provide an efficient and compact representation of the entire set of data elements. The VC may provide efficient proofs and operations for individual data elements within the set. This may enable various functionalities, such as efficient verification of the state changes in a block, efficient synchronization of light clients, or efficient proofs of inclusion or non-inclusion of specific data elements.

In some non-limiting embodiments or aspects, the VC may provide additional KVAC properties for implementing blockchain network 100.

In some non-limiting embodiments or aspects, VC may support an algorithm to extend a length of the VC and may output one or more new parameters as described above for the extended length. In some examples, the VC inherits all the VC properties such as multi-hop aggregation.

The accumulators may be used to store and maintain the commitments for the key-value pairs. Specifically, each key-value pair may be hashed using a collision-resistant hash function to produce a commitment value in an accumulator structure (e.g., accumulator commitment, vector commitment, etc.) using an appropriate update algorithm (shown above).

In some non-limiting embodiments or aspects, blockchain system 200 may provide an accumulator data structure that provides efficient, secure updates and queries. Each block may represent a subset of the key-value pairs, and the root block may contain the commitment for the entire set of key-value pairs in all the blocks of blockchain network 100.

In some non-limiting embodiments or aspects, blockchain system 200 may add a new key-value pair to the key-value maps 106a-106n. For example, in some non-limiting embodiments or aspects, blockchain system 200 may provide blockchain node software 210 for the party who will add a key-value pair, such as by selecting a unique key and computing its corresponding value. Blockchain system 200 generates a commitment to the existing key-value pairs for the party in the map using the VC and/or accumulator commitment. Blockchain system 200 then computes a new commitment value for the party by adding the commitment value of the existing map to the commitment of the new key-value pair. Blockchain system 200 then publicly discloses the new commitment value for the party along with a proof that the new key-value pair is included in the commitment. One or more other parties may verify the proof using the public parameters of blockchain network 100 and the new commitment value to ensure that the new key-value pair is included in the map.

In some non-limiting embodiments or aspects, blockchain system 200 proves the inclusion of a particular key-value pair in the accumulator. For example, a prover may need to provide a proof consisting of a set of sibling keys in the accumulator, along with their corresponding hashes that may be used to verify the key-value pair in the block.

In some non-limiting embodiments or aspects, blockchain system 200 updates a value for the party by computing a new commitment value using an updated key-value pair. Blockchain system 200 then generates a proof to show that the old value was replaced by the new value. The proof may include a constant number of group elements and may be verified by blockchain system 200 using just a few group exponentiations. The updated commitment value and the proof are then published to blockchain network 100, allowing others to verify that the old value was replaced by the new value.

In some non-limiting embodiments or aspects, a new key may be used by an online store to introduce a new product to your customers. In order to do this, the store would need to add a new key-value pair to your map. The key could be the name or SKU of the new product and the value could include information such as the product description, price, and availability. Once the key-value pair has been added to the map, it may be committed using the KVAC so that customers may verify the authenticity of the product information.

In some non-limiting embodiments or aspects, a new key may be used to record ownership of property, where each property is represented by a unique identifier (the key) and a set of attributes such as the owner, the address, and the assessed value (the value). If the assessed value of a property changes due to a change in market conditions, an update to the value associated with the property's identifier may be necessary to reflect the new value accurately. For example, blockchain system 200 modifies the original key-value pair to include the new value and then computes a new commitment value for the updated key-value map.

In some non-limiting embodiments or aspects, the use of accumulators in the KVC provides an efficient and secure way to store and maintain the commitments for large numbers of key-value pairs, while also enabling efficient and secure proofs of inclusion and non-inclusion. For example, blockchain system 200 provides a commitment that provides constant-size proofs of membership for key-value maps, without requiring the commitment size to grow as the number of keys in the KV-map grow. The encoding and proofs may comprise just two and three group elements respectively making them highly efficient.

Blockchain system 200 provides a chaining technique which links together multiple key-value pairs into a single chain. Each chain has a fixed size determined by a security parameter, and each key-value pair is assigned to a specific chain using a pseudorandom function (PRF). The chain is then represented by a single commitment value that is computed using a homomorphic hash function.

In some non-limiting embodiments or aspects, blockchain system 200 may prove membership of a key-value pair in the accumulator. For example, a prover may provide a proof consisting of two group elements (e.g., a commitment value for the chain that contains the key-value pair, and a proof of inclusion in that chain, etc.). In another example, blockchain system 200 provides a proof of inclusion comprising three group elements (e.g., a commitment value for the key-value pair, a witness for the PRF used to assign the key-value pair to the chain, and a representation of the key-value pair with respect to the commitment value for the chain, etc.).

In some non-limiting embodiments or aspects, blockchain system 200 verifies the proof. Blockchain system 200 computes a plurality of group exponentiations and a plurality of hash function evaluations. Updating the accumulator to include a new key-value pair involves adding it to the appropriate chain, recomputing the commitment values for the affected chains, and updating a representation.

Blockchain system 200 may generate a commitment value for a key-value pair based on the specific key and its associated value using a cryptographic commitment. This commitment value is included in accumulator data structure to represent the key-value pair in blockchain network 100.

Blockchain system 200 may generate a commitment value for blockchain network 100 that represents an entire state of blockchain network 100, including each of the key-value pairs that have been committed to blockchain network 100 over time. Such a commitment value may be computed using similar cryptographic commitment s. The commitment value may include each of the nodes in the accumulator data structure (e.g., accumulator commitment data structure, VC data structure, etc.), not just a single key-value pair. This allows the entire blockchain network 100 to be represented by a single commitment value making it easier to verify the integrity of the entire blockchain network 100.

In some non-limiting embodiments or aspects, one or more keys represent the unique identifiers for the key-value pairs. The one or more keys may be used to index the values in the data structure and compute the commitment value for the KVAC.

In some non-limiting embodiments or aspects, blockchain system 200 may commit to a set of key-value pairs using the KVC, a party first computes a commitment value based on a polynomial generated from the key-value pairs. The commitment value may be published publicly, while the key-value pairs remain private.

When the party desires to prove that a particular key-value pair was included in the commitment, blockchain system 200 may generate a cryptographic proof using the commitment value and the relevant key-value pair. Blockchain system 200 may verify the proof. For example, the proof is verified by any third party using blockchain system 200 without revealing any information about the other key-value pairs in the commitment.

Blockchain system 200 provides a way (e.g., one or more properties or algorithms, as shown above, etc.) to update a value associated with a particular key in the key-value map without having to compute a new commitment value for the entire map. Instead, an additive update to the value associated with the key may be made, and a new commitment value may be computed based on the updated map.

Blockchain system 200 provides additive updates to key values using the same level of efficiency as proofs of membership. In this way, the cost of updating a value associated with a key is the same as the cost of proving that a particular key-value pair is a member of the map. In both cases, only a few group exponentiations are required to compute the updated commitment value or the proof of membership. This is advantageous in situations where the key-value map is frequently updated as it allows for efficient updates without requiring the entire map to be recomputed.

In some non-limiting embodiments or aspects, blockchain system 200 provides an accumulator commitment for membership and non-membership proofs in blockchain system 200. The accumulator may be used to generate proofs for both membership and non-membership of data elements in the set.

In some non-limiting embodiments or aspects, blockchain system 200 proves that a data element is a member of a set. For example, blockchain system 200 generates a membership proof using the accumulator for the prover. The membership proof includes a subset of accumulated values along with other necessary information. For example, blockchain system 200 allows the verifier to verify that the data element is included in the set. The verifier may then efficiently verify the membership proof using the accumulator without having to individually check each element in the set.

In some non-limiting embodiments or aspects, blockchain system 200 proves that a data element is not a member of a set. For example, blockchain system 200 generates a non-membership proof using the accumulator for the prover. The non-membership proof includes a subset of accumulated values along with other necessary information. For example, blockchain system 200 allows the verifier to verify that the data element is not included in the set. The verifier may then efficiently verify the non-membership proof using the accumulator without having to check each element in the set.

In this example, the accumulator is used for both membership and non-membership proofs allowing the prover to efficiently prove the existence or non-existence of data elements in the set depending on the scenario. This may be useful in various blockchain network 100 use cases where efficient verification of membership or non-membership is required, such as verifying the validity of transaction inputs or outputs, checking for duplicate entries, or verifying access control to certain data or resources.

In some non-limiting embodiments or aspects, blockchain system 200 provides an accumulator commitment that supports non-membership for element k. In some non-limiting embodiments or aspects, a KVC is derived from an accumulator commitment. In such an example, a KVC is derived from a VC via an accumulator commitment. Alternatively, a VC may be derived from the accumulator commitment.

In some non-limiting embodiments or aspects, an accumulator may be generated from a VC. For example, each VC position corresponds to one accumulator domain element. In some examples, a position opening to 1 (e.g., one) corresponds to membership of the element, opening to 0 (e.g., zero) corresponds to non-membership. Such a proof may support both non-membership and extended VC properties and accumulator commitment properties. To instantiate, according to some non-limiting embodiments or aspects, blockchain system 200 may include a commitment to a complete accumulator domain (e.g., an operation equivalent to running a VC setup over a structure including each key of the possible key-value pair, etc.).

In some non-limiting embodiments or aspects, VC and accumulator commitments are cryptographic primitives that provide efficient ways to verify the integrity and membership of data elements in a compact manner.

For example, VC allow for the representation of a vector of data elements, such as a list or an array and provide efficient proofs of existence or non-existence of specific elements within the vector. VC may be more efficient than existing primitives when operating on sets of data that may require frequent updates or random access.

In another example, accumulator commitments allow the accumulation of multiple data elements into a single commitment, which may be efficiently and accurately verified. They may also provide a way to verify the membership or non-membership of specific elements in a set without revealing an entire set. Accumulators may be more efficient than existing primitives when operating on large data sets, such as, when efficient proof generation and verification is needed.

By utilizing VC and accumulator commitments, blockchain system 200 may achieve efficient verification of membership and non-membership, ensuring the validity of transaction inputs and outputs, detecting duplicate entries, and providing data integrity. These cryptographic primitives play a crucial role in maintaining the security and efficiency of blockchain network 100.

In some non-limiting embodiments or aspects, a state of blockchain network 100 (e.g., cryptocurrency network, ledger network, etc.) refers to a current snapshot or representation of the entire blockchain network 100 at a particular point in time. The state includes all the relevant data and information necessary to describe the current status and condition of the network.

In the context of blockchain network 100, the state typically includes various components, such as account balances, transaction history, smart contract states, network parameters, other relevant data, and/or the like. For example, one or more account balances may represent the amount of cryptocurrency held by each account/address in the network. A transaction history may include a record of each of the transactions that have occurred within the network, including sender, receiver, and transaction details. In some examples, smart contract states are stored, if the network supports smart contracts. The current state of deployed contracts may include variable values and contract-specific data. Network parameters may include configuration settings and rules governing the operation of the network, such as block size, block time, consensus algorithm, and/or the like. Additional information that may be specific to the network, such as token standards, governance protocols, or identity management systems may also be stored.

The state of a cryptocurrency network is dynamic and continuously evolving. For example, as blockchain system 200 obtains or stores each new transaction or block added to blockchain network 100, substantially simultaneous, with the storing of the changes made to the state. The state comprises a representation of the current truth (e.g., the validity of the transactions, KVC, etc.) of the network. Blockchain system 200 may use the state to validate transactions, enforce rules, maintain consensus across the network, and/or the like.

Blockchain system 200 may maintain an accurate and up-to-date representation of the network's state to ensure proper functioning of the cryptocurrency ecosystem. Blockchain system 200 may ensure that participants may reliably determine account balances, verify the validity of transactions, and make informed decisions based on the current state of the network.

Blockchain system 200 may use KVCs from accumulators and VC to provide KVC that offer succinct encodings of key-value maps resulting in compact commitment values. In such an example, regardless of the number of items (e.g., one or more key-value pairs, etc.) committed, the commitment value consists of just two group elements. Blockchain system 200 provides compact representation, reduces storage requirements, enables faster data processing, and/or the like.

Blockchain system 200 may use KVC generated from accumulators and VC for efficient membership proofs. For example, proving the existence of a certain item in the commitment requires only three group elements. The verification of such proofs requires only five exponentiations. This efficiency reduces the computational overhead associated with validating the membership of specific items. Succinctness of a proof, as used herein, refers to the property of a proof whereby the size of the proof is relatively small compared to the size of the statement being proven. In other words, a succinct proof provides a compact representation of the evidence or information needed to demonstrate the validity or truth of a statement.

Blockchain system 200 may generate encodings that reduce a computational and communication overhead associated with verifying the proof. A succinct proof allows for more efficient verification processes as it requires fewer computational resources and less data transmission. For example, blockchain system 200 may provide a succinct proof by using advanced cryptographic techniques. Blockchain system 200 may minimize the size of the proof while still providing a convincing demonstration of the statement's validity, in this way, optimizing cryptographic techniques of blockchain network 100, such as zero-knowledge proofs, probabilistically checkable proofs, succinct data structures, and/or the like.

Blockchain system 200 may provide succinct proofs, so that cryptographic systems may operate more efficiently, allow for faster verification, and reduce the overall resource requirements. This property is particularly important in blockchain system 200 and other distributed environments where the verification of proofs needs to be performed by multiple parties across the network.

Blockchain system 200 may use KVC from accumulators and VC to provide fast updates. For example, blockchain system 200 may insert new items, update the values of existing items (e.g., additive updates, etc.), update membership proofs, and/or the like. In any update scenario, at most four exponentiations are required. In such an example, updating the value of an item does not require knowledge of its existing value, enhancing the flexibility and efficiency of the update process.

Blockchain system 200 may use KVC from accumulators and VC to provide a trustless blockchain network 100 (e.g., a system or protocol design where participants may interact and transact without needing to trust each other or rely on a centralized authority, etc.). As an example, blockchain system 200 may provide an encoding that may be established without relying on a centralized or trusted authority. In some examples, blockchain system 200 uses a trustless blockchain network 100 to enhance decentralization, security, and trustworthiness of blockchain system 200 and blockchain network 100. In such an example, blockchain system 200 enhances the security and correctness of blockchain network 100. For example, blockchain system 200 may provide a trustless blockchain network 100 so that participants do not have to trust that other actors will behave honestly or that a central authority will not abuse its power.

Blockchain system 200 may determine or provide cryptographic primitives and consensus mechanisms formed from accumulator commitments and VC to verify transactions, verify exchanges of information, verify proofs or statements, perform other operations, and/or the like without having to trust other participants or a central authority. In some non-limiting embodiments or aspects, blockchain system 200 may provide a trustless blockchain network 100 using cryptographic techniques, such as public-key cryptography, digital signatures, zero-knowledge proofs, distributed consensus algorithms, proof-of-work algorithms, proof-of-stake algorithms, and/or the like. Blockchain system 200 provides commitments from accumulators and VC to independently verify the validity and integrity of transactions, proofs, system states, and/or the like without a need to trust other parties. In this way, participants may engage in interactions with blockchain network 100 with reduced reliance on external entities. In this way, blockchain system 200 may provide commitments from accumulators and VC to mitigate the risk of fraud, manipulation, or censorship. Trustless setups are commonly found in blockchain network 100 and other decentralized systems where participants seek to maintain control over their assets and information without relying on a central authority.

In some non-limiting embodiments or aspects, blockchain system 200 may use KVC from accumulators and VC to allow for the aggregation and batching of multiple proofs. Multiple proofs may be combined into a single proof, reducing the overall proof size and enabling efficient verification. The time required to verify aggregated proofs is like verifying a single proof, facilitating faster validation of a batch of proofs.

Batching in VC may refer to the ability to commit to multiple VC simultaneously using a single commitment. Instead of committing to individual vectors separately, a single VC may be used to commit to a list of vectors in one shot. For example, blockchain system 200 may generate a matrix M whose columns are the vectors to be committed to. The commitment to the matrix M is then computed, and this commitment may be used by blockchain system 200 to verify any linear combination of the vectors in the matrix. To prove that a specific vector is in the matrix, the prover would need to provide a witness that proves knowledge of the corresponding row i of the matrix. Batching may greatly reduce the communication and computation costs of VC, especially when dealing with large numbers of vectors.

The number and arrangement of systems and devices shown in FIG. 2 are provided as an example. There may be additional systems and/or devices, fewer systems and/or devices, different systems and/or devices, and/or differently arranged systems and/or devices than those shown in FIG. 2. Furthermore, two or more systems or devices shown in FIG. 2 may be implemented within a single system or device, or a single system or device shown in FIG. 2 may be implemented as multiple, distributed systems or devices. Additionally, or alternatively, a set of systems (e.g., one or more systems) or a set of devices (e.g., one or more devices) of blockchain system 200 may perform one or more functions described as being performed by another set of systems or another set of devices of system 200.

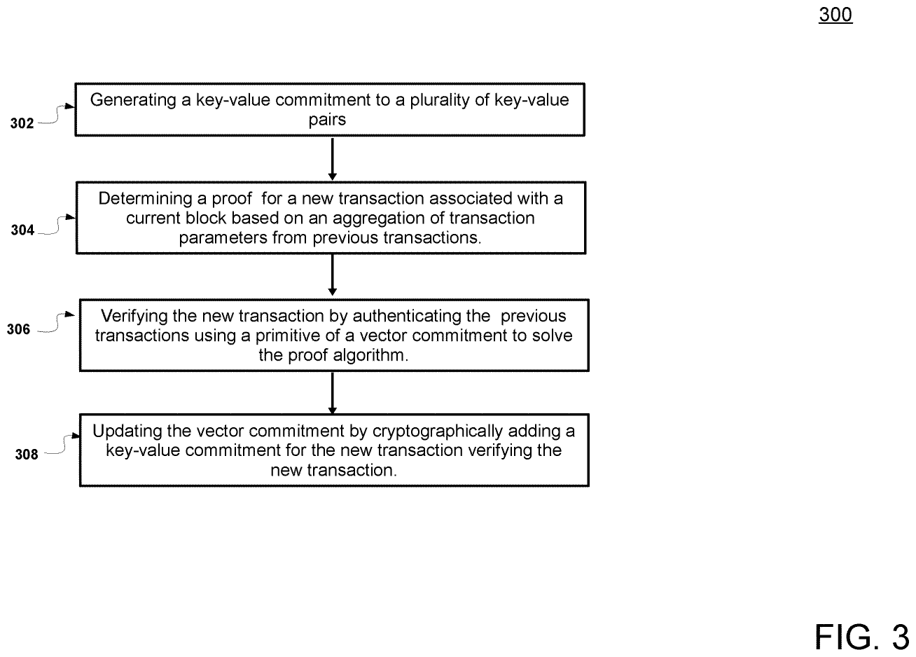

Referring now to FIG. 3, shown is a flow diagram for a method for generating KVC from VC according to some non-limiting embodiments or aspects. In some non-limiting embodiments or aspects, one or more of the steps of process 300 may be performed (e.g., completely, partially, and/or the like) in a decentralized, distributed ledger that may be public or private, such as blockchain network 100 (e.g., one or more blocks of blockchain network 100, structures of blockchain network 100, etc.) by blockchain system 200 (e.g., one or more devices of blockchain system 200). In some non-limiting embodiments or aspects, one or more of the steps of process 300 may be performed (e.g., completely, partially, and/or the like) by another system, another device, another group of systems, or another group of devices, separate from or including the aforementioned devices, such as transaction submission system 202, commitment generation system 204, transaction authorization system 206, block generation system 208, or commitment verification system 212.

As shown in FIG. 3, at step 302, process 300 may include generating a KVC to a plurality of key-value pairs. For example, blockchain system 200 generates a KVC to a plurality of key-value pairs. Blockchain system 200 generates an accumulator commitment, a VC, or a KVC for a plurality of key-value pairs of a block in a blockchain network.

In some non-limiting embodiments or aspects, for example, blockchain system 200 generates a KVC to a plurality of key-value pairs based on a cryptographic data structure that allows a user to commit to a vector (e.g., an ordered set, etc.) of values such that the user may later reveal and prove the value of specific elements without revealing the entire vector. Operation includes primitives for inserting new values, updating existing values, deleting values from the VC, and/or the like. State transition, as used herein, may refer to the change in the state of a system or ledger. For example, a state transition typically refers to the change in the blockchain's state due to the addition of a new transaction. For example, the state of an account balance before and after a transaction. A blockchain where each block contains several transactions, and the VC is used to manage and verify the state of the blockchain efficiently for a new block of transactions added.

In some non-limiting embodiments or aspects, proofs may be generated for each operation: This may include proofs for each transaction verifying the addition or update of data within the VC. In one example, a proof may verify that the state of the blockchain has transitioned correctly. This proof verifies that blockchain network 100 has moved from the previous valid state (before the transactions in the new block) to the new valid state (after the transactions have been processed).

In some non-limiting embodiments or aspects, generating a commitment to a plurality of key-value pairs for a current block in blockchain network 100 includes the commitment to the plurality of key-value pairs stored in a VC comprising a key vector and a corresponding value vector. The key vector and the corresponding value vector each include a vector length. The vector length is increased as additional key-value pairs are stored to the VC.

In some non-limiting embodiments or aspects, blockchain system 200 generates a commitment to a plurality of key-value pairs for a current block in blockchain network 100. The commitment to the plurality of key-value pairs may be stored in a VC comprising a key vector and a corresponding value vector. The key vector and the corresponding value vector each include a vector length configured to be increased as additional key-values are stored to the VC.

As an example, blockchain system 200 obtains key-value pairs for a transaction or a current block in blockchain network 100. Blockchain system 200 then generates a commitment to each of the key-value pairs for a current block (e.g., as the key-value pairs are obtained, in a batch, etc.). The commitment to the plurality of key-value pairs may then be stored in a VC. The VC may include a key vector and a corresponding value vector, such that the key vector and the corresponding value vector each have a vector length configured to be increased (e.g., as key-values arrive, are obtained, handled, etc.). The additional key-values are stored to the VC.

In some non-limiting embodiments or aspects, blockchain system 200 generates an accumulator commitment from the VC. For example, blockchain system 200 may generate an accumulator commitment by converting each key-value pair of the plurality of key-value pairs of the VC to a corresponding key-value pair of the accumulator commitment. For example, each VC element corresponds to one accumulator domain element.

In some non-limiting embodiments or aspects, blockchain system 200 generates the accumulator commitment from the VC to extend the at least one property of the VC (e.g., each VC includes properties for manipulating the VC, etc.). For example, blockchain system 200 extends the VC to include one or more properties of the accumulator commitment for operating on a plurality of KVC. For example, blockchain system 200 extends the VC to include one or more properties of the accumulator commitment, such as membership, non-membership, and/or the like. In some non-limiting embodiments or aspects, blockchain system 200 may test membership and non-membership to determine a presence of a key.

In some non-limiting embodiments or aspects, blockchain system 200 transforms each key-value pair of the plurality of key-value pairs of the VC. In such an example, blockchain system 200 encodes a plurality of keys of the plurality of key-value pairs. Blockchain system 200 may encode the plurality of keys into a probabilistic data structure. For example, blockchain system 200 may encode the plurality of keys (e.g., the VC, etc.) to include a test algorithm that provides a signal in response to determining a given key is in a set. In this way, blockchain system 200 compresses a plurality of values of the plurality of key-value pairs into a compact format. Additionally, blockchain system 200 encodes the plurality of values to provide access to information (e.g., cryptographically derived information, etc.) associated with the plurality of values when compared to one or more test values.

In some non-limiting embodiments or aspects, blockchain system 200 encodes the VC by encoding the plurality of values directly as a linear function to form a linear combination of one or more vector elements. The additions, updates, modifications, and/or deletions of values to the VC may then be made by updating the linear function directly (e.g., aggregating updates with existing values, accumulating, etc.).

In some non-limiting embodiments or aspects, each encoded key of a plurality of encoded keys of the VC may be represented by a corresponding hexadecimal string based on the one or more key-value pairs. The encoded keys may be compacted (or compressed) to between 2-bytes and 6-bytes.

In some non-limiting embodiments or aspects, generating a compact representation of the plurality of keys by hashing each key of the plurality of keys and resetting bits for each hashed key based on one or more resulting hash values, wherein the compact representation of the plurality of keys is configured to store the plurality of keys and information for querying the one or more key-value pairs.

In some non-limiting embodiments or aspects, a root of each block comprises a commitment to a state of a corresponding block. In some examples, each block of blockchain network 100 represents a subset of the key-value pairs. The state of each previous block in the blockchain network 100 is cryptographically included in each subsequent header of each subsequent block as a commitment to a previous state of blockchain network 100. For example, blockchain system 200 stores a cryptographic value in a current block that cryptographically represents information about a previous block that is used to form a commitment to a previous state of blockchain network 100 (e.g., or a current state of blockchain network 100 as the new block is added, etc.).

As shown in FIG. 3, at step 304, process 300 may include determining a proof for a new transaction associated with a current block based on an aggregation of transaction parameters from previous transactions. In some non-limiting embodiments or aspects, commitment generation system 204, transaction authorization system 206, block generation system 208, or blockchain node software 210 determine a proof for a new transaction associated with a current block based on an aggregation of transaction parameters from previous transactions.

In some non-limiting embodiments or aspects, commitment generation system 204, transaction authorization system 206, block generation system 208, and/or blockchain node software 210 may determine a proof algorithm for a new transaction associated with the current block based on an aggregation of transaction parameters from one or more previous transactions. For example, in some non-limiting embodiments or aspects, blockchain system 200 determines a proof algorithm for a new transaction associated with the current block based on an aggregation of transaction parameters from one or more previous transactions.

In some non-limiting embodiments or aspects, blockchain system 200 determines the proof algorithm for the new transaction. For example, blockchain system 200 generates a plurality of proofs, such that each of the plurality of proofs correspond to an update operation of the VC. The plurality of proofs may include at least one proof configured to verify a state transition of an update operation.

In some non-limiting embodiments or aspects, blockchain system 200 aggregates the plurality of proofs into a batch. In some non-limiting embodiments or aspects, the VC provides a key-value map.

In some non-limiting embodiments or aspects, blockchain system 200 verifies the plurality of proofs in the batch. For example, blockchain system 200 verifies the plurality of proofs in the batch based on a single computation of the VC.

In some non-limiting embodiments or aspects, blockchain system 200 generates a verification result based on a plurality of proofs.

In some non-limiting embodiments or aspects, access to a plurality of values of the commitment is provided by blockchain system 200 in response to a proof of knowledge determination of the key-value map for a key in the VC. For example, blockchain system 200 receives, transmits, obtains, and/or the like, a proof of knowledge determination of the key-value map for a key in the VC. In some examples, one or more blocks participate in transaction verification based only on commitment to a state without storing a current state of blockchain network 100.

As shown in FIG. 3, at step 306, process 300 may include verifying the new transaction by authenticating the previous transactions using a primitive of a VC to solve the proof algorithm. For example, in some non-limiting embodiments or aspects, blockchain system 200 verifies the new transaction by authenticating the previous transactions using a primitive of a VC to solve the proof algorithm.

In some non-limiting embodiments or aspects, blockchain system 200 verifies the new transaction based on authenticating the one or more previous transactions using at least one primitive of the VC to solve the proof algorithm. For example, in some non-limiting embodiments or aspects, blockchain system 200 verifies the new transaction based on authenticating the one or more previous transactions using at least one primitive of the VC to solve the proof algorithm.

In some non-limiting embodiments or aspects, blockchain system 200 authenticates the one or more previous transactions without revealing one or more intermediate state transitions or an entire key-value map of the blockchain network 100. For example, blockchain system 200, by using at least one primitive of the accumulator commitment to execute the proof algorithm, verifies at least one of a signature, a proof of membership, a state of the VC, or an amount associated with at least one transaction of the one or more previous transactions, wherein the proof algorithm is a multi-hop proof algorithm.

In some non-limiting embodiments or aspects, blockchain system 200 provides multi-hop aggregation. For example, multi-hop aggregation in conjunction with VC may aggregate or accumulate data elements in a vector through a series of hops or intermediate stages rather than aggregating them all at once. Multi-hop aggregation provides improved efficiency in terms of computational cost, communication overhead, and storage requirements.

For example, blockchain system 200 provides multi-hop aggregation instead of recomputing an entire commitment. This may eliminate high computational cost and communication overhead, especially for large vectors. Blockchain system 200 provides multi-hop aggregation so that updates may be performed incrementally through intermediate stages allowing for more efficient computation and communication.

In some non-limiting embodiments or aspects, blockchain system 200 divides the VC into smaller segments or partitions and performs local aggregation or commitment on each segment. In such an example, the resulting intermediate commitments are then combined or aggregated to form a global commitment for the entire vector. This process may be repeated in multiple stages, with each stage aggregating a smaller set of commitments, until the final global commitment is obtained. This allows for more efficient updates and verifications, as only a subset of commitments need to be recomputed and communicated at each stage, instead of the entire vector.

In some non-limiting embodiments or aspects, blockchain system 200 adds a new transaction that requires referencing previous inputs. For example, a user may want to transfer digital assets or cryptocurrencies from one account to another. This process typically involves creating a new transaction that includes the sender's account information, the recipient's account information, and the amount of digital assets or cryptocurrencies being transferred.

In some non-limiting embodiments or aspects, blockchain system 200 ensures that the sender has the authority to spend the digital assets or cryptocurrencies being transferred. As an example, blockchain system 200 ensures a new transaction references the previous transaction outputs (or inputs) that are associated with the sender's account. For example, previous transaction outputs serve as the source of funds for the new transaction, and their inclusion in the new transaction provides evidence that the sender has the right to spend those specific digital assets or cryptocurrencies.

In some non-limiting embodiments or aspects, blockchain system 200 verifies the existence and validity of the referenced previous inputs by checking the corresponding proofs. For example, blockchain system 200 may generate multi-hop aggregation proofs for VC. Once the referenced inputs are verified, the new transaction is considered valid and may be added to blockchain network 100 or ledger as a new block. The new transaction and updated blockchain network 100 or ledger then serve as the basis for subsequent transactions and updates in blockchain system 200.

Blockchain system 200 may authenticate the new transaction based on verifying membership or non-membership of a key-value pair. For example, blockchain system 200 verifies the new transaction after determining the one or more previous transactions are authenticated. For example, blockchain system 200 authenticates the new transaction using at least one primitive of the VC to solve the proof algorithm. In another example, blockchain system 200 authenticates the new transaction using at least one primitive of the accumulator commitment to solve the proof algorithm. For example, by converting the VC to an accumulator commitment, the corresponding key-value pair in the accumulator commitment is used by blockchain system 200 to authenticate the new transaction. For example, blockchain system 200 determines at least one property of the accumulator commitment (e.g., membership, non-membership, etc.) to use for authenticating a new transaction.

With continued reference to FIG. 3, at step 308, process 300 may include updating the VC by cryptographically adding a KVC for the new transaction verifying the new transaction. For example, blockchain system 200 updates the VC by adding a key-value pair to the VC for the new transaction in response to verifying the new transaction.

In some non-limiting embodiments or aspects, blockchain system 200 updates the VC by adding a key-value pair to the VC for the new transaction in response to verifying the new transaction.

In some non-limiting embodiments or aspects, blockchain system 200 determines a current state of blockchain network 100. For example, the current state of blockchain network 100 as determined in the VC is based on the current block of the blockchain network 100. However, each previous VC representing each previous block of blockchain network 100 may be used to ensure the previous state of the blockchain (e.g., before the current block, etc.).

In some non-limiting embodiments or aspects, a state of each previous block is determined by a commitment value of a key-value map stored for each previous block of blockchain network 100. For example, blockchain system 200 determines a current state of blockchain network 100 based on a key-value map stored in a VC or an accumulator commitment of the key-value pairs. For example, the VC stores a representation of the key-value map associated with the current state of the current block. However, blockchain system 200 determines the current state of blockchain network 100 by aggregating each VC stored in each previous block of blockchain network 100 (e.g., a root of each block, a root node, etc.). For example, each new block in blockchain network 100 stores a reference back to a VC of a previous block (as shown in FIG. 1) of blockchain network 100. Blockchain system 200 may aggregate each VC reference to determine or generate a state of blockchain network 100.

In some non-limiting embodiments or aspects, one or more key-value pairs of the VC of the previous block may be accessed for information that verifies at least one transaction of the current block.

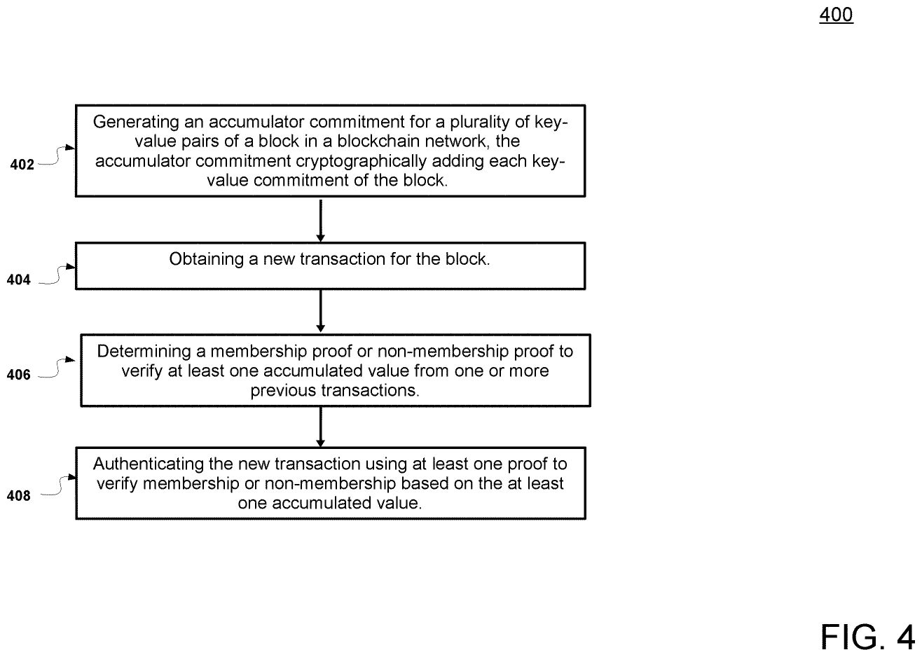

Referring now to FIG. 4, a flowchart of an example process 400 for KVC from accumulators according to some non-limiting embodiments or aspects. In some non-limiting embodiments or aspects, one or more of the steps of process 400 may be performed (e.g., completely, partially, and/or the like) in a decentralized, distributed ledger that may be public or private, such as blockchain network 100 (e.g., one or more blocks blockchain network 100, structures of blockchain network 100, etc.) by blockchain system 200 (e.g., one or more devices of blockchain system 200). In some non-limiting embodiments or aspects, one or more of the steps of process 400 may be performed (e.g., completely, partially, and/or the like) by another system, another device, another group of systems, or another group of devices, separate from or including the aforementioned devices, such as transaction submission system 202, commitment generation system 204, transaction authorization system 206, block generation system 208, or commitment verification system 212.

As shown in FIG. 4, at step 402, process 400 may include generating an accumulator commitment for a plurality of key-value pairs of a block in a blockchain network, the accumulator commitment cryptographically adding each KVC of the block. For example, in some non-limiting embodiments or aspects, blockchain system 200 generates an accumulator commitment for a plurality of key-value pairs of a block in a blockchain network, the accumulator commitment cryptographically adding each KVC of the block.

In some non-limiting embodiments or aspects, generating an accumulator commitment for a plurality of key-value pairs of a block in a blockchain network includes generating an accumulator commitment by creating a single cryptographic value (e.g., the accumulator commitment), which represents each of the key-value pairs in a block, another quantifiable structure, and/or the like. There are multiple key-value pairs within the block. Each key-value pair is a distinct piece of data where the key is an identifier and the value is the associated data. Each block may include several transactions or pieces of data represented as key-value pairs.

In some non-limiting embodiments or aspects, block generation system 208 generates the accumulator commitment cryptographically by adding each KVC. This means that for each key-value pair in the block, an individual cryptographic commitment is made. One or more individual commitments are then combined (e.g., added, accumulated, etc.) into a single accumulator commitment using the cryptographic properties and operations described herein.

In some non-limiting embodiments or aspects, block generation system 208 generates the accumulator commitment cryptographically such that the accumulator commitment securely encapsulates all the individual KVC. This allows anyone with the accumulator commitment to verify that a specific key-value pair is included in the block without having to reference the entire block's data. The single commitment provides the verification of any individual key-value pair's inclusion in the block enhancing the integrity and security of the data within the blockchain.

In some non-limiting embodiments or aspects, blockchain system 200 generates a commitment to a plurality of key-value pairs for a block in blockchain network 100, the commitment to the plurality of key-value pairs stored in an accumulator commitment comprising each key-value pair, the accumulator commitment comprising each new key added to the block and at least one value commitment associated with each new key added to the block. For example, in some non-limiting embodiments or aspects, blockchain system 200 generates a commitment to a plurality of key-value pairs for a block in blockchain network 100. The commitment to the plurality of key-value pairs may be stored by blockchain system 200 in an accumulator commitment. As an example, blockchain system 200 generates the accumulator commitment to each key-value pair, such that each new key added to the block and at least one value are included in a commitment. The commitment is associated (e.g., stores, links, etc.) to each new key added to the block.

In some non-limiting embodiments or aspects, a root of each block (e.g., a root of each block stored in a header block, etc.) comprises a commitment to a state of a corresponding block. Additionally, the state of each previous block in blockchain network 100 is cryptographically included in each subsequent header of each subsequent block as a commitment to a previous state of blockchain network 100. For example, each block stores the commitment to a state of the previous block which cryptographically includes the commitment to the state of each previous block.

In some non-limiting embodiments or aspects, each block of blockchain network 100 represents a subset of the key-value pairs, such as the subset of the key-value pairs that form blockchain network 100.

In some non-limiting embodiments or aspects, blockchain system 200 transforms each key-value pair of the plurality of key-value pairs of the accumulator commitment. For example, blockchain system 200 encodes a plurality of keys of the plurality of key-value pairs into a probabilistic data structure by encoding the plurality of keys to include a test algorithm that provides a signal in response to determining a given key is in a set.

In some non-limiting embodiments or aspects, blockchain system 200 compresses a plurality of values of the plurality of key-value pairs into a compact format. For example, blockchain system 200 compresses a plurality of values to provide access to information associated with the plurality of values when compared to one or more test values.

In some non-limiting embodiments or aspects, blockchain system 200 compresses a plurality of values to encode the VC. In some examples, blockchain system 200 encodes the VC directly as a linear function to form a linear combination of one or more vector elements of the VC. The encoded key (e.g., each of a plurality of encoded keys of the vector commitment, etc.) may be represented by a corresponding hexadecimal string based on the one or more key-value pairs. The encoded key may be compacted to between 2-bytes and 6-bytes.

In such an example, the additions, updates, modifications, and/or deletions of values to the VC are made by updating the linear function directly.

In some non-limiting embodiments or aspects, blockchain system 200 generates a compact representation of the plurality of keys. For example, blockchain system 200 hashes each key of the plurality of keys and resetting bits for each hashed key based on one or more resulting hash values. The compact representation of the plurality of keys may be configured to store the plurality of keys, such that the compact representation includes information for querying the one or more key-value pairs.

As shown in FIG. 4, at step 404, process 400 may include obtaining a new transaction for the block. For example, in some non-limiting embodiments or aspects, blockchain system 200 obtains a new transaction for the block.

In some non-limiting embodiments or aspects, blockchain system 200 determines a multi-hop proof algorithm for a second transaction. For example, blockchain system 200 generates a VC from the accumulator commitment. In such an example, blockchain system 200 converts each KVC of the plurality of key-value pairs of the accumulator commitment to a corresponding KVC of the VC. Blockchain system 200 also authenticates the second transaction. Blockchain system 200 determines at least one property of the VC to execute the multi-hop proof algorithm. Blockchain system 200 updates the accumulator commitment by adding a key-value pair to the accumulator commitment for the second transaction. For example, in response to verifying the second transaction based on the VC, blockchain system 200 updates the accumulator commitment by adding a key-value pair to the accumulator.

In some non-limiting embodiments or aspects, blockchain system 200 generates the VC from the accumulator commitment. For example, blockchain system 200 extends a property of the accumulator commitment to include one or more properties of the VC for operating on the plurality of key-value pairs. The VC then increases in length to commit each KVC stored by the accumulator commitment. In some examples, blockchain system 200 generates the accumulator commitment from a VC by matching each position of the VC to a domain element of the accumulator commitment. This allows blockchain system 200 to increase the length of the VC to include each key of a plurality of potential keys to commit the domain element of the accumulator commitment.

In some non-limiting embodiments or aspects, block generation system 208, commitment verification system 212, and/or transaction authorization system 206 determine a multi-hop proof algorithm for a second transaction.

For example, block generation system 208, commitment verification system 212, and/or transaction authorization system 206 select or compute a specific algorithm that will generate a proof spanning multiple transactions. A multi-hop proof allows verification across several stages (e.g., hops, etc.) to secure a transaction's validity so that it is traced through a sequence of related transactions.

In some non-limiting embodiments or aspects, block generation system 208, commitment verification system 212, and/or transaction authorization system 206 generate a VC from an accumulator commitment by converting each KVC of the plurality of key-value pairs of the accumulator commitment to a corresponding KVC of the VC. For example, block generation system 208, commitment verification system 212, and/or transaction authorization system 206 converts (e.g., translate, repurpose, etc.) the existing accumulator commitment into a VC. In some non-limiting embodiments or aspects, block generation system 208, commitment verification system 212, and/or transaction authorization system 206 convert the commitments of individual key-value pairs from the accumulator structure into a format suitable for a VC. This conversion ensures that each key-value pair is represented accurately within the new commitment structure.

In some non-limiting embodiments or aspects, block generation system 208, commitment verification system 212, and/or transaction authorization system 206 authenticate the second transaction by using at least one property of the VC to execute the multi-hop proof. For example, in some non-limiting embodiments or aspects, block generation system 208, commitment verification system 212, and/or transaction authorization system 206 execute (e.g., perform, instantiate, produce, etc.) properties of the VC to verify a transaction. The VC may provide a framework that supports efficient verification via its properties (e.g., succinctness and security) to validate the transaction through the multi-hop proof. In some non-limiting embodiments or aspects, block generation system 208, commitment verification system 212, and/or transaction authorization system 206 verifies that the transaction is legitimate and correctly related to previous transactions.

In some non-limiting embodiments or aspects, block generation system 208, commitment verification system 212, and/or transaction authorization system 206 update the accumulator commitment by adding a key-value pair to the accumulator commitment for the second transaction in response to verifying the second transaction based on the VC. For example, after the second transaction is authenticated, block generation system 208, commitment verification system 212, and/or transaction authorization system 206 update the accumulator commitment to include a new key-value pair corresponding to the second transaction. In some non-limiting embodiments or aspects, block generation system 208, commitment verification system 212, and/or transaction authorization system 206 verify or prove that the accumulator reflects the most recent state of the blockchain incorporating the verified transaction into its cryptographic structure.

As shown in FIG. 4, at step 406, process 400 may include determining a membership proof or non-membership proof configured to verify at least one accumulated value from one or more previous transactions. For example, in some non-limiting embodiments or aspects, blockchain system 200 determines a membership proof or non-membership proof configured to verify at least one accumulated value from one or more previous transactions.

In some non-limiting embodiments or aspects, blockchain node software 210 generates or solves a membership proof. For example, a cryptographic proof that a specific key-value pair is included in the accumulator commitment (e.g., ACC 108a-108n, etc.). To verify that a particular key-value pair exists within a block, the membership proof relies on the previously generated accumulator commitment to confirm the inclusion without revealing all data.

In some non-limiting embodiments or aspects, blockchain node software 210 generates or solves a non-membership proof. A non-membership proof is a cryptographic proof that a specific key-value pair is not included in the accumulator commitment (e.g., conversely to the membership proof which verifies existence, etc.). The non-membership proof signals that a particular key-value pair is absent from the block. It also relies on the accumulator commitment to verify absence securely.

In some non-limiting embodiments or aspects, blockchain node software 210 verifies accumulated values from previous transactions. For example, the membership and non-membership proofs may be used to verify accumulated values from one or more previous transactions. This means that these proofs are not just limited to the current block but may also be used to check the inclusion or exclusion of key-value pairs in earlier blocks.

In some non-limiting embodiments or aspects, blockchain node software 210 verifies that accumulated values may verify inclusion, for example, blockchain node software 210 proves that a key-value pair is part of the accumulated data. In another example, blockchain node software 210 verifies exclusion, thereby proving that a key-value pair is not part of the accumulated data. Still another example, blockchain node software 210 provides historical verification, for example, blockchain node software 210 checks accumulated values across multiple blocks, not just a current block (e.g., not just a block containing the current transaction, etc.). This improves the integrity and trustworthiness of data in blockchain network 100 allowing users to efficiently verify the presence or absence of specific data without needing to access or process the entire dataset.

In some non-limiting embodiments or aspects, blockchain node software 210 generates or provides an accumulator commitment that comprises cryptographic representation encapsulating multiple key-value pairs associated within a block.

In some non-limiting embodiments or aspects, blockchain node software 210 confirms a membership proof. For example, when a particular key-value pair exists within the accumulator commitment. For example, when a new transaction is added to the blockchain, blockchain node software 210 may authenticate key-value pairs against the existing accumulated values.

In some non-limiting embodiments or aspects, blockchain node software 210 confirms non-membership proof. Blockchain node software 210 confirms that a particular key-value pair does not exist within the accumulator commitment. Blockchain node software 210 also confirms that duplicate or unauthorized key-value pairs are not added to the blockchain.

With continued reference to FIG. 4, at step 408, process 400 may include authenticating the new transaction using at least one proof to verify membership or non-membership based on the at least one accumulated value. For example, blockchain node software 210 or blockchain system 200 authenticate the new transaction using at least one primitive of the accumulator commitment to verify membership or non-membership of the at least one accumulated value. For example, in some non-limiting embodiments or aspects, blockchain system 200 authenticates the new transaction using at least one primitive of the accumulator commitment to verify membership or non-membership of the at least one accumulated value.

In some non-limiting embodiments or aspects, block generation system 208 verifies new transactions. For example, when a new transaction is processed, block generation system 208 authenticates by using the membership or non-membership proofs generated from the accumulator commitment. For each key-value pair involved in the new transaction, block generation system 208 verifies whether it should be included or excluded based on the accumulated values from previous transactions. For example, if the new transaction attempts to add a key-value pair that already exists in the accumulated values, the membership proof will confirm its presence, preventing duplicates. Conversely, the non-membership proof will ensure that new key-value pairs are legitimate and not previously included.

Block generation system 208 verifies the integrity of the blockchain by preventing unauthorized changes and verifying that each new transaction match (e.g., conform, fit, accept, etc.) the existing state of accumulated data. The use of these cryptographic primitives enhances trust in the blockchain's immutability and correctness.

In some non-limiting embodiments or aspects, based on one or more proofs, block generation system 208 verifies efficiently and securely validates whether the data in the new transactions is consistent with the previously accumulated values while maintaining or addressing the integrity and reliability of the blockchain.

In some non-limiting embodiments or aspects, transaction authorization system 206, block generation system 208, blockchain node software 210, commitment verification system 212, create accumulator commitments. For example, blockchain node software 210 combines multiple key-value pairs into a single, compact commitment. For example, blockchain node software 210 generates hash functions or other cryptographic techniques to ensure the commitment is secure and efficient.

In some non-limiting embodiments or aspects, transaction authorization system 206, block generation system 208, blockchain node software 210, commitment verification system 212 create the accumulator commitment from a set of key-value pairs.

In some non-limiting embodiments or aspects, transaction authorization system 206, block generation system 208, blockchain node software 210, commitment verification system 212, generate the membership and non-membership proofs.

In some non-limiting embodiments or aspects, transaction authorization system 206, block generation system 208, blockchain node software 210, commitment verification system 212, verify these proofs to authenticate new transactions in the blockchain network. In some non-limiting embodiments or aspects, transaction authorization system 206, block generation system 208, blockchain node software 210, commitment verification system 212 activate (e.g., use) primitives for ensuring the security, efficiency, and integrity of the accumulator commitment process within the blockchain.

In some non-limiting embodiments or aspects, a state of each previous block is determined by a commitment value of a key-value map stored for each previous block of blockchain network 100. For example, blockchain system 200 determines a current state of blockchain network 100 based on a key-value map stored in a VC or an accumulator commitment of the key-value pairs. For example, the VC stores a representation of the key-value map associated with the current state of the current block. However, blockchain system 200 determines the current state of blockchain network 100 by aggregating each VC stored in each previous block of blockchain network 100 (e.g., a root of each block, etc.). For example, each new block in blockchain network 100 stores a reference back to a VC of a previous block of blockchain network 100, by aggregating each VC reference a state of the blockchain network 100 is generated.

In some non-limiting embodiments or aspects, one or more key-value pairs of the VC of the previous block may be accessed for information that verifies at least one transaction of the current block.

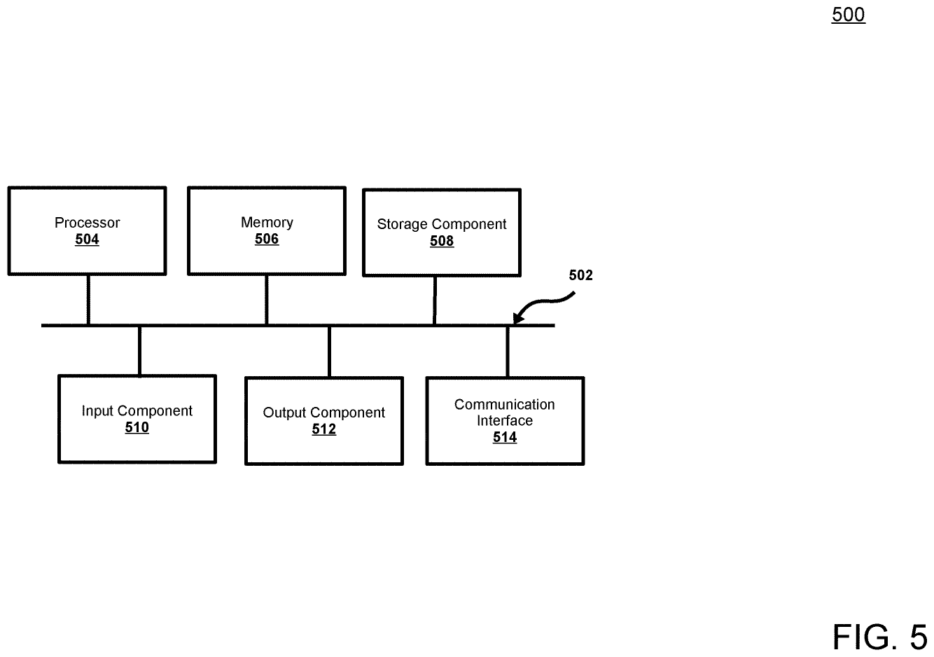

Referring now to FIG. 5, shown is a diagram of example components of device 500, according to some non-limiting embodiments or aspects. Device 500 may correspond to one or more devices (e.g., one or more servers, one or more processors, one or more mobile devices, etc.) in blockchain system 200. Transaction submission system 202, commitment generation system 204, transaction authorization system 206, block generation system 208, blockchain node software 210, and/or commitment verification system 212 of FIG. 2. Device 500 may correspond to one or more devices (e.g., one or more servers, one or more processors, one or more mobile devices, etc.) for executing blockchain network 100. In some non-limiting embodiments or aspects, such systems or devices may include at least one device 500 and/or at least one component of device 500. The number and arrangement of components shown are provided as an example. In some non-limiting embodiments or aspects, device 500 may include additional components, fewer components, different components, or differently arranged components than those shown in FIG. 1. Additionally, or alternatively, a set of components (e.g., one or more components) of device 500 may perform one or more functions described as being performed by another set of components of device 500.

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments or aspects, processor 504 may be implemented in hardware, firmware, or a combination of hardware and software. For example, processor 504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that may be programmed to perform a function. Memory 506 may include random access memory (RAM), read only memory (ROM), and/or another type of dynamic or static storage device (e.g., flash memory, magnetic memory, optical memory, etc.) that stores information and/or instructions for use by processor 504.

With continued reference to FIG. 5, storage component 508 may store information and/or software related to the operation and use of device 500. For example, storage component 508 may include a hard disk (e.g., a magnetic disk, an optical disk, a magneto-optic disk, a solid-state disk, etc.) and/or another type of computer-readable medium. Input component 510 may include a component that permits device 500 to receive information, such as via user input (e.g., a touch screen display, a keyboard, a keypad, a mouse, a button, a switch, a microphone, etc.). Additionally, or alternatively, input component 510 may include a sensor for sensing information (e.g., a global positioning system (GPS) component, an accelerometer, a gyroscope, an actuator, etc.). Output component 512 may include a component that provides output information from device 500 (e.g., a display, a speaker, one or more light-emitting diodes (LEDs), etc.). Communication interface 514 may include a transceiver-like component (e.g., a transceiver, a separate receiver and transmitter, etc.) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium may include any non-transitory memory device. A memory device includes memory space located inside of a single physical storage device or memory space spread across multiple physical storage devices. Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment may be combined with one or more features of any other embodiment. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

1. A system, comprising:
at least one processor, configured to:
generate an accumulator commitment for a plurality of key-value pairs of a block in a blockchain network, the accumulator commitment cryptographically adding each key-value commitment of the block;
obtain a new transaction for the block;
determine a membership proof or non-membership proof to verify at least one accumulated value from one or more previous transactions; and
authenticate the new transaction based on at least one proof to verify membership or non-membership based on the at least one accumulated value.

2. The system of claim 1, wherein the at least one processor is further programmed or configured to:
determine a multi-hop proof for a plurality of transactions;
generate a vector commitment from the accumulator commitment by converting each key-value commitment of the plurality of key-value pairs of the accumulator commitment to a corresponding key-value commitment of the vector commitment;
authenticate at least one second transaction by using at least one property of the vector commitment to execute the multi-hop proof; and
update the accumulator commitment by adding a key-value pair to the accumulator commitment for the second transaction in response to verifying the second transaction based on the vector commitment.

3. The system of claim 2, wherein generating the vector commitment from the accumulator commitment extends at least one property of the accumulator commitment to include one or more properties of the vector commitment to operate on the plurality of key-value pairs, wherein the vector commitment increases in length to commit each key-value commitment stored by the accumulator commitment, and the increases in the length of the vector commitment comprise a plurality of keys that commit a domain of the accumulator commitment.

4. The system of claim 1, wherein the at least one processor is further programmed or configured to:
determine a current state of the blockchain network based on combining the accumulator commitment of a current block of the blockchain network with each previous accumulator commitment representing each previous block of the blockchain network,
wherein a state of each previous block is determined by a commitment value of a key-value map stored for each previous block of the blockchain network, wherein the accumulator commitment includes a key-value map associated with the current state of the current block, wherein the current state of the blockchain network is determined by accumulating each accumulator commitment stored in each previous block of the blockchain network, wherein each new block in the blockchain network stores a reference back to a accumulator commitment of a previous block of the blockchain network, and wherein one or more key-value pairs of the accumulator commitment of the previous block comprises information that verifies at least one transaction of the current block.

5. The system of claim 4, wherein the at least one processor is further programmed or configured to:
transform each key-value pair of the plurality of key-value pairs of the accumulator commitment by:
encoding a plurality of keys of the plurality of key-value pairs into a probabilistic data structure by encoding the plurality of keys to include a test indicator that provides a signal in response to determining a specified key is in a set; and
compressing a plurality of values of the plurality of key-value pairs into a compact format that provides access to information associated with the plurality of values when compared to one or more test values.

6. The system of claim 5, wherein the at least one processor is further programmed or configured to:
generate a compact representation of the plurality of keys by hashing each key of the plurality of keys and resetting bits for each hashed key based on one or more resulting hash values, wherein the compact representation of the plurality of keys is configured to store the plurality of keys and information for querying the one or more key-value pairs.

7. The system of claim 6, wherein the accumulator commitment is associated with a key-value map, wherein access to a plurality of values of the accumulator commitment is provided in response to a proof of knowledge determination of the key-value map for a key in the accumulator commitment, and wherein one or more blocks participate in transaction verification based only on commitment to a state without storing a current state of the blockchain network.

8. The system of claim 7, wherein the state of each previous block in the blockchain network is cryptographically included in each subsequent block as a commitment to a previous state of the blockchain network.

9. The system of claim 8, wherein each encoded key of a plurality of encoded keys of the accumulator commitment are each represented by a corresponding hexadecimal string based on the one or more key-value pairs and are compacted to between 2-bytes and 6-bytes.

10. A computer-implemented method, comprising:
generating an accumulator commitment for a plurality of key-value pairs of a block in a blockchain network, the accumulator commitment cryptographically adding each key-value commitment of the block;
obtaining a new transaction for the block;
determining a membership proof or non-membership proof to verify at least one accumulated value from one or more previous transactions; and
authenticating the new transaction based on at least one proof to verify membership or non-membership based on the at least one accumulated value.

11. The computer-implemented method of claim 10, comprising:
determining a multi-hop proof algorithm for a second transaction;
generating a vector commitment from the accumulator commitment by converting each key-value commitment of the plurality of key-value pairs of the accumulator commitment to a corresponding key-value commitment of the vector commitment;
authenticating the second transaction using at least one property of the vector commitment to execute the multi-hop proof algorithm; and
updating the accumulator commitment by adding a key-value pair to the accumulator commitment for the second transaction in response to verifying the second transaction based on the vector commitment.

12. The computer-implemented method of claim 11, wherein generating the vector commitment from the accumulator commitment extends at least one property of the accumulator commitment to include one or more properties of the vector commitment to operate on the plurality of key-value pairs, wherein the vector commitment increases in length to commit each key-value commitment stored by the accumulator commitment, and the increases in the length of the vector commitment comprise a plurality of keys that commit a domain of the accumulator commitment.

13. The computer-implemented method of claim 10, further comprising:
determining a current state of the blockchain network based on combining the accumulator commitment of a current block of the blockchain network with each previous accumulator commitment representing each previous block of the blockchain network,
wherein a state of each previous block is determined by a commitment value of a key-value map stored for each previous block of the blockchain network, wherein the accumulator commitment includes a key-value map associated with the current state of the current block, wherein the current state of the blockchain network is determined by accumulating each accumulator commitment stored in each previous block of the blockchain network, wherein each new block in the blockchain network stores a reference back to a accumulator commitment of a previous block of the blockchain network, and wherein one or more key-value pairs of the accumulator commitment of the previous block comprises information that verifies at least one transaction of the current block.

14. The computer-implemented method of claim 13, further comprising:
transforming each key-value pair of the plurality of key-value pairs of the accumulator commitment by:
encoding a plurality of keys of the plurality of key-value pairs into a probabilistic data structure by encoding the plurality of keys to include a test indicator that provides a signal in response to determining a specified key is in a set; and
compressing a plurality of values of the plurality of key-value pairs into a compact format that provides access to information associated with the plurality of values when compared to one or more test values.

15. The computer-implemented method of claim 14, wherein encoding the plurality of keys using a probabilistic data structure comprises:
generating a compact representation of the plurality of keys by hashing each key of the plurality of keys and resetting bits for each hashed key based on one or more resulting hash values, wherein the compact representation of the plurality of keys is configured to store the plurality of keys and information for querying the one or more key-value pairs.

16. The computer-implemented method of claim 15, wherein the accumulator commitment is associated with a key-value map, wherein access to a plurality of values of the accumulator commitment is provided in response to a proof of knowledge determination of the key-value map for a key in the accumulator commitment, and wherein one or more blocks participate in transaction verification based only on commitment to a state without storing a current state of the blockchain network.

17. The computer-implemented method of claim 16, wherein the state of each previous block in the blockchain network is cryptographically included in each subsequent block as a commitment to a previous state of the blockchain network.

18. The computer-implemented method of claim 17, wherein each encoded key of a plurality of encoded keys of the accumulator commitment are each represented by a corresponding hexadecimal string based on the one or more key-value pairs and are compacted to between 2-bytes and 6-bytes.

19. A computer program product, comprising at least one non-transitory computer-readable medium including program instructions that, when executed by at least one processor, cause the at least one processor to:
generate an accumulator commitment for a plurality of key-value pairs of a block in a blockchain network, the accumulator commitment cryptographically adding each key-value commitment of the block;
obtain a new transaction for the block;
determine a membership proof or non-membership proof to verify at least one accumulated value from one or more previous transactions; and
authenticate the new transaction based on at least one proof to verify membership or non-membership based on the at least one accumulated value.

20. The computer program product of claim 19, wherein the at least one non-transitory computer-readable medium includes further program instructions that, when executed by at least one processor, cause the at least one processor to:
determine a multi-hop proof for a plurality of transactions;
generate a vector commitment from the accumulator commitment by converting each key-value commitment of the plurality of key-value pairs of the accumulator commitment to a corresponding key-value commitment of the vector commitment;
authenticate at least one second transaction by using at least one property of the vector commitment to execute the multi-hop proof; and
update the accumulator commitment by adding a key-value pair to the accumulator commitment for the second transaction in response to verifying the second transaction based on the vector commitment.

21-40. (canceled)
